(19) United States
(12) Patent Application Publication
(10) Pub. No.: US 2022/0355257 A1
(43) Pub. Date: Nov. 10, 2022

(54) Emulsion Formation Assisted by Corona Discharge and Electrohydrodynamic Pumping

(71) Applicant: The University of Toledo, Toledo, OH (US)

(72) Inventors: Hossein Sojoudi, Toledo, OH (US); Mohcen Shahbaznezhad, Toledo, OH (US); Amir Dehghanghadikolaei, Toledo, OH (US)

(73) Assignee: The University of Toledo, Toledo, OH (US)

(21) Appl. No.: 17/737,325

(22) Filed: May 5, 2022

Related U.S. Application Data
(60) Provisional application No. 63/185,514, filed on May 7, 2021.

(51) Int. Cl. B01F 23/411; B01F 23/41

(52) U.S. Cl. CPC B01F 23/411; B01F 23/4143

(57) ABSTRACT

Methods and systems for creating emulsions are described. Also described are the emulsions created by the methods or with the systems.

### RELATED APPLICATIONS

This application claims priority to U.S. Provisional Application No. 63/185,514 filed under 35 U.S.C. § 111(b) on May 7, 2021, the disclosure of which is incorporated herein by reference in its entirety for all purposes.

### STATEMENT REGARDING FEDERALLY SPONSORED RESEARCH

This invention was made with no government support. The government has no rights in this invention.

### BACKGROUND

Emulsions are formed from two naturally immiscible liquids from which one is dispersed uniformly or non-uniformly into the other phase. The most common emulsions are water-in-oil (W/O) emulsions (e.g., butter) and oil-in-water (O/W) emulsions (e.g., milk), which can be in different size-categories of macro, nano, and micro emulsions in the ranges of 0.5-100 μm, 0.1-1 μm, and 0.01-0.1 μm, respectively. The range of dispersity of one phase in the other phase may vary based on their physical conditions and chemical compositions. However, many of the immiscible liquids can not be combined into an emulsion due to differences in their properties (affinity of one material to the other one). In this case, there has to be a mediating agent (i.e., surfactant) in order to combine the two phases and make them stably mixed for a long period of time. Accordingly, conventional techniques commonly require water, oil, energy/power, and surfactant (emulsifier compound) to form emulsions.

Emulsions are used in numerous industries such as cosmetics, drug delivery, food products, oil and gas, materials processing, and pharmaceuticals. Traditional emulsion formation processes heavily depend on the industry and final product that has the emulsion, ranging from electroemulsification to ultrasonication. Emulsions can also be categorized based on other parameters such as the chemicals used in their formation processes. However, conventional emulsion formation methods, which are typically categorized as either high-energy or low-energy processes, have various disadvantages.

Emulsion formation methods that implement a high mechanical shear rate in the liquid medium in order to break down the large droplets of one immiscible liquid and disperse it into the other liquid homogeneously are referred to as high-energy methods. In these methods, the energy consumption is considerably high (≈10⁸-10¹⁰ W/kg) and the droplets of dispersed phase are relatively large (i.e., 0.1˜1 μmn). The high-energy methods are mostly referred to as ultrasonication and high-pressure homogenization (HPH) which work based on different concepts. In the ultrasonication method, the base medium and the additive material (either water or oil) are added to a container and the ultrasonic probe is placed in the container as well. After starting to vibrate with a high frequency, the two phases start to break down and mix. Although the two phases do not chemically bond, since they get broken into small pieces, they form a semi-stable mixture that can last for a considerable time. In the HPH process, the liquids are added into a container and a pump pushes them with extremely high pressure through small orifices which breaks down the particles into tiny sizes, making them form a semi-stable emulsion similar to the ultrasonication process. The stability of the emulsion depends on the droplet sizes dispersed in the base medium. One limitation of these processes is that only two-phase emulsions can be formed (i.e., W/O or O/W). The most common high-energy methods of emulsion formation are ultrasonic emulsification, high-pressure homogenization, mechanical blending (blade stirring), and microfluidics and membrane systems. However, high-pressure homogenization (HPH) and ultra-high-pressure homogenization (UHPH) are the most commonly implemented methods in commercial and industrial applications, especially in dairy industries.

In low-energy emulsification methods, the liquids are mixed together without using mechanical forces. The most common of these methods work based on the composition of the two liquid phases and the temperature at which they are treated. Based on these two, low-energy emulsification methods are categorized into distinct processes such as emulsion inversion point (EIP), phase inversion composition (PIC), phase inversion temperature (PIT), direct emulsification inversion (DEI), and spontaneous emulsification (SE). In contrast to the high-energy emulsification methods, these methods are temperature/composition-driven with a significantly lower energy consumption (10³-10⁵ W/kg). In these processes, the emulsion is formed by either controlling the temperature of the process or the composition of the chemicals used in the process. For instance, in phase-inversion composition, the emulsion is made after adding an adequate concentration of an agent known as emulsifier/surfactant which connects water and oil molecules in chemical ways. As a result, an emulsion can be obtained that is stable after having the correct amount of the emulsifier agent. The same process takes place in phase-inversion temperature in which the emulsifier agent works based on the change in temperature, producing an emulsion at the end. However, the low-energy processes have the limitations of less flexibility in the selection of oils and working temperature, and also a relatively high concentration of surfactant, which are not desirable in most applications.

Based on the availability of the facilities and materials, either of the low- or high-energy emulsification methods may be implemented in forming a new emulsion product, but in each of them there are limitations such as chemical composition, working temperature, energy consumption, change of material properties, etc. On the other hand, most of these emulsification processes are non-continuous with a limited production rate since an external factor affects the emulsion phases (i.e., agitators, blades, chemicals, etc.).

One problem with current low-energy emulsion formation processes is that the procedure is highly sensitive to the chemical composition of the liquids or the temperature in which the emulsification process takes place. Also, the number of oils suitable for these processes and the number of specific emulsifiers that could be utilized are both limited. Furthermore, the process suffers from a drastic drop in efficiency in higher viscosities. The fact that in some cases a very high concentration of emulsifier is needed increases the difficulties of using this process as a high-yielding alternative. The high-energy process also has a similar problem with high-viscosity oils, dropping the efficiency significantly. Other than that, the high-pressure methods utilize high-speed rotary parts and high-frequency motions that cause considerable wear in the equipment and corrosion/erosion in the pipelines, creating excessive maintenance cost. In addition, the debris from corrosion/erosion of the equipment causes pollution of the emulsions with unwanted materials. Moreover, the common shortcoming of the high- and low-energy methods is that the processes are not continuous and the batch production increases the overall cost of the product.

High-energy methods have high maintenance costs, high power consumption, cause wear and degradation of rotary equipment, involve a change in medium properties by pressure and temperature, create medium pollution by corrosion/wear byproducts, have lower flexibility in production, involve discontinuous production, and have difficulties associated with high viscosity liquids. Low-energy methods are sensitive to temperature/chemical composition, have low efficiency working with high viscosity oils, have a limited range of oil selection, involve a discontinuous production/process, and have a need for a high concentration of surfactants.

Use of electric fields to form emulsions has also been previously studied with a minimal need for surfactants and without physical/mechanical disturbance to the emulsification environment. It is hypothesized that during the electroemulsification some charge residue remains in the emulsion and charges which agree (either positive or negative depending on discharge polarity) are repelled by each other and build-up higher zeta potential, consequently forming more stable emulsions. With power consumption significantly less than those of the high-energy emulsification methods, electroemulsification is a reliable replacement for low- and high-energy methods (especially in high viscosity liquids). In addition, electroemulsification can enable encapsulation of liquids and formation of O/W/O or W/O/W emulsions, when compared to regular W/O and O/W emulsions that are formed by low- and high-energy methods. These complex emulsions (O/W/O or W/O/W) are widely used in biomedical, drug delivery, and medicine applications. Also, it has been hypothesized that the electroemulsification can build-up residual charges which consequently can increase stability of emulsions in their shelf life. But none of these methods can provide practical solutions to be implemented in real industrial applications, mainly due to difficulties of designing mechanical setups capable of addressing production line requirements. During electroemulsification, a major problem is coalescence between like-phase droplets as a side effect of the applied electric field in the continuous phase, which is against the emulsification and is not desirable. To address this, a couple of methods have been introduced such as using a magnetic stirrer or rotary drum, but none can be scaled up for industrial application. In addition, problems like high dependency to dispersed phase properties, coalescence during the emulsification process, and power consumption remain to be solved.

Furthermore, conventional methods for forming emulsions need to be used in batch sequences while almost all production lines are continuous processes. Thus, there is a need for emulsion formation methods that can be operated as continuous processes.

In view of the above, there is a need in the art for new and improved systems and methods for forming emulsions.

### SUMMARY

Provided is a method for forming a water-in-oil (W/O) emulsion, the method comprising subjecting a corona emitting electrode to a high voltage sufficient to form a corona discharge and create an ionic wind drifting in a direction toward a ground electrode, wherein the ground electrode is immersed in a fluid comprising a first phase comprising an oil at a position offset from the corona emitting electrode, and wherein the corona discharge causes electrohydrodynamic pumping of the fluid; and introducing a second phase comprising water to the ionic wind while the fluid is moving from the electrohydrodynamic pumping so as to introduce charged particles of the second phase to the fluid and cause the charged particles to diffuse and submerge as droplets in the first phase and thereby form a W/O emulsion. In certain embodiments, the corona emitting electrode is a sharp conductive needle.

In certain embodiments, the high voltage is direct current (DC). In certain embodiments, the high voltage is alternating current (AC). The method provides for power efficient W/O emulsion formation.

In certain embodiments, the method further comprises adjusting a velocity of the first liquid phase by changing one or more parameters selected from the group consisting of voltage, electrode configuration, oil viscosity in the first fluid phase, and operating frequency.

In certain embodiments, the method further comprises collecting and removing the W/O emulsion.

In certain embodiments, the droplets are micro- to nano-sized droplets. The first phase may comprise a wide range of dieelectric oils. In certain embodiments, the first phase comprises silicone oil.

In certain embodiments, the fluid consists of the first phase prior to the introduction of the second phase to the flow of ionized particles/ionic wind.

In certain embodiments, the method is a continuous process such that the second phase is continuously introduced, the fluid is continuously allowed to move, and the emulsion is continuously collected and removed. In certain embodiments, the ground electrode is not offset from the corona emitting electrode and an external pumping source makes a fluid flow.

In certain embodiments, a second corona discharge is emitted from a second corona emitting electrode, and the channel further comprises a second ground electrode disposed at a distance away from the second corona emitting electrode lesser than a distance between the second corona emitting electrode and the first ground electrode.

Further provided is a method for forming a water-in-oil (W/O) emulsion, the method comprising emitting a corona discharge from a corona emitting electrode to provide a flow of ionized particles moving in a direction toward a ground electrode, wherein the ground electrode is immersed in a fluid comprising a first phase comprising an oil; causing relative motion between the fluid and the corona emitting electrode; introducing a second phase comprising water to the flow of ionized particles so as to introduce charged particles of the second phase to the fluid during the relative motion; and allowing the relative motion to cause the charged particles of the second phase to spread out as droplets in the first phase and thereby form a W/O emulsion. In certain embodiments, the relative motion is caused by introducing a flow of the fluid. In certain embodiments, the relative motion is caused by moving the corona emitting electrode relative to the ground electrode. In certain embodiments, the corona emitting electrode is disposed a distance d away from the fluid, and is offset from the ground electrode by a length L, where L is at least equal to or greater than 2.15×d(tan(65°)×d).

Further provided is a system for creating a water-in-oil (W/O) emulsion comprising a channel configured to receive a fluid; a ground electrode disposed in the channel; a corona emitting electrode disposed at a distance away from the channel and configured to emit a corona discharge; and a source of a water droplets disposed in proximity to the corona emitting electrode so as to be configured to provide the water droplets in a space between the corona emitting electrode and the channel.

In certain embodiments, the corona emitting electrode is offset from the ground electrode. In certain embodiments, the corona emitting electrode is configured for relative movement with respect to a liquid phase in the channel. In certain embodiments, the system further comprises a power source and an amplifier configured to supply a differential potential to the corona emitting electrode. In certain embodiments, the source of water droplets is a humidifier. In certain embodiments, the channel is circular. However, the channel may be any shape. In certain embodiments, the channel comprises an inlet and an outlet. In certain embodiments, the channel comprises one or more additional valves. In certain embodiments, the humidifier is a micro or nano humidifier. In certain embodiments, arrays of channels can be utilized for mass production of the W/O emulsion.

In certain embodiments, the system further comprises a second corona emitting electrode and a second ground electrode, wherein the second ground electrode is in the channel, and wherein the second corona emitting electrode is disposed at a position offset from the second ground electrode by a distance that is lesser than a distance from the second corona emitting electrode to the first ground electrode. In particular embodiments, the system further comprises a second source of water droplets configured to provide water droplets in proximity to the second corona emitting electrode. In certain embodiments, the corona emitting electrode is the the array of electrodes. In certain embodiments, the corona emitting electrode can be substituted by a wire electrode.

Further provided is a method for forming a water-in-oil (W/O) emulsion, the method comprising emitting a corona discharge from a corona emitting electrode to provide a flow of ionized particles moving in a direction toward a ground electrode, wherein the ground electrode is immersed in a fluid comprising a first phase comprising an oil at a position offset from the corona emitting electrode, and wherein the flow causes electrohydrodynamic pumping of the fluid; introducing a second phase comprising water to the flow of ionized particles so as to introduce charged particles of the second phase to the fluid while the fluid is moving from the electrohydrodynamic pumping; and allowing the fluid to move from the electrohydrodynamic pumping to cause the charged particles of the second phase to spread out as droplets in the first phase and thereby form a water-in-oil (W/O) emulsion.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1: Schematic of a non-limiting example embodiment of a system for forming a W/O emulsion in accordance with the present disclosure, having a single electrode configuration.

FIG. 2: Schematic of a non-limiting example embodiment of a system for forming a W/O emulsion in accordance with the present disclosure, having a multiple electrode configuration.

FIG. 3: Top-down schematic of a non-limiting example embodiment of a system for forming a W/O emulsion in accordance with the present disclosure, having a circular track.

FIG. 4: Schematic of a non-limiting example embodiment of a system for forming a W/O emulsion in accordance with the present disclosure, where the ground electrode is not offset from the corona emitting electrode and an external pumping source induces a fluid flow.

FIG. 5: Schematic of a non-limiting example embodiment of a system for forming a W/O emulsion in accordance with the present disclosure, where the corona emitting electrode is moved relative to the ground electrode.

FIG. 6: Photograph of a non-limiting example system for forming a W/O emulsion in accordance with the present disclosure. The inset shows a close-up view of the space between the emitting electrode and the ground electrode.

FIG. 7: Microscopy images of water-in-oil emulsions formed using corona discharge with varying oil viscosity. The top panel shows the water droplets inside the silicone oil continuous phase. Distribution and size of the water droplets are comparable, regardless of different viscosity oils. The bottom panel shows higher magnification microscopy images of the identified sections of the images shown in the top panel. The images show micrometer-sized droplets of water in silicone oil.

FIG. 8: Illustration of the discharge mechanism.

FIG. 9: Photograph of water droplet manipulation during active corona discharge.

FIG. 10: Photograph showing the electrohydrodynamic pumping of oil created by the corona discharge can be used in conjunction with water droplets to create water-in-oil emulsions.

FIGS. 12A-12C: Negative corona discharge characterization on the pin-to-plate configuration. The corona onset voltage was found to be 3 kV in all corona gaps (t, distance between the pin and the plate). In all cases, the relationship between the voltage and the current/voltage datapoints is linear, which verifies the Townsend's regime characteristics of the corona discharge. FIGS. 12A-12C show size and distribution of water droplets inside the silicone oil with viscosity of 100 cSt (FIG. 12A), 200 cSt (FIG. 12B), and 350 cSt (FIG. 12C). Regardless of oil viscosity, the distribution number of the water droplets significantly decreases by an increase in the droplet sizes, which is in accord with the measured sizes of the water droplets formed by the humidifier. This indicates successful immersion of water droplets, without major coalescence, inside various silicone oil mediums.

FIG. 13: Plot of current versus the applied voltage to the tip of the corona generating needle (pin). Regardless of silicone oil viscosity, the measured current is minimal and following the same trend when the applied voltage is below 7 kV. After this voltage, higher viscosity oil undergoes a considerable surface deformation, opening a clear path for ions created by the needle (pin) to directly reach the ground electrode (plate). As a result, the sharp peaks of instantaneous increase in the current can be seen for oils with viscosities of 200 cSt and 350 cSt, when compared to the low-viscosity silicone oil (100 cSt).

FIG. 14: Cross-section images of the silicone oil deformation under the corona discharge. In the top panel, by increasing the oil viscosity, a slight increase in the surface deformation of the oil is observed, which results in lower electrical resistance between the needle or oil surface and the ground electrode (at the bottom of the oil) and higher current passing through the oil. The bottom panel shows oil deformation (cone formation) from the increase in the applied electric field. The observed deformation is enhanced for the oil with highest viscosity (350 cSt). The cone formation results in a back-vortex flow which is not favorable for the emulsion formation using the corona discharge. For emulsion formation, applied voltage and other parameters may be adjusted for a given oil to avoid its deformation.

FIG. 15: The graph on the left shows the average size of three different measurement tests on the outlet of the humidifier used for Example II herein. The measured size of the water droplets produced by the humidifier stabilized after nearly 40 seconds at approximately 1.62 μm. The chart on the right shows the average number counted for each size category.

FIG. 16: The effect of electric field and voltage (V) on the size of water droplets in emulsions. The experiments were performed on silicone oil with 100 cSt viscosity mixed with 1 wt. % of Span 80 surfactant agent under constant vertical distance of h=15 mm, horizontal distance of L=20 mm, and oil thickness of t=8 mm, and one round of processing with voltage varying between +6 and +10 KV in 1 KV increment. The top chart illustrates the average water droplet sizes for different voltage levels. An increase in the applied voltage leads to a more uniform emulsion. As the voltage gets lower, the circulation velocity of the oil becomes less, and the already-injected droplets are more likely to coalesce with the new incoming droplets and causes a wide range of sizes. The bottom-left image is a representative optical microscopy (OM) image of the emulsion formed under +10 kV. The bottom-right image is a high-resolution OM image showing water droplets as small as a couple of micrometers in the emulsion.

FIG. 17: The effect of vertical distance between the tip of the sharp needle electrode and the top of the oil surface (h) on the size of water droplets. The experiments were performed on silicone oil with 100 cSt viscosity mixed with 1 wt. % of Span 80 surfactant agent under constant horizontal distance of L=20 mm, voltage of V=10 KV, oil thickness of t=8 mm, and one round of processing with vertical distance varying between 10 and 35 mm with 5 mm increments. The chart at the top shows the average water droplet sizes for different vertical distances. With an increase in the vertical distance the emulsion becomes more nonuniform with larger size water droplets. At the same time, the range of smallest to largest size of droplets are increasing while the vertical distance is increased. The bottom-left image is a representative optical microscopy (OM) image of the emulsion formed under 10 mm of vertical distance. The bottom-right image is a high-resolution OM image showing water droplets as small as a couple of micrometers in the emulsion.

FIG. 18: Schematic view of the different components of the EHD forces generated by the electric field, and its corresponding horizontal, vertical, and radial distances of x, y, and r, respectively. As the horizontal (x) or vertical (y) components of r increase, the overall distance between the two electrodes increases as well.

FIG. 19: The effect of horizontal distance between the tip of the needle electrode to the starting point of the grounded electrode, L. The experiments were performed on silicone oil with 100 cSt viscosity mixed with 1 wt. % Span 80 surfactant agent under constant voltage of V=+8 kV, vertical electrode distance of h=15 mm, oil thickness of t=8 mm, and one round of processing with horizontal distance varying between 5 and 30 mm in increments of 5 mm. The chart at the top shows the average water droplet sizes for different horizontal distances. By a constant increase in the values of the horizontal distance, the average size of the water droplets was decreased to a point and after that it started increasing again. The bottom-left image is a representative optical microscopy (OM) image of the emulsion formed under 20 mm of horizontal distance. The bottom-right image is a high-resolution OM image showing water droplets as small as a couple of micrometers in the emulsion.

FIG. 20: Schematic representation of a shift in the location of the ground electrode and the new path of discharge. The electrical resistivities of air, silicone oil, and PE petri dish become a series of electrical resistances. As the distance in which the charged droplets move increases, the total resistance of the medium increases as well. As a result, Path 2 provides less electrical resistance compared to Path 1.

FIG. 21: The effect of oil thickness (oil height in the pump), t, on the average size of the water droplets. The experiments were performed on silicone oil 100 cSt viscosity mixed with 1 wt. % Span 80 surfactant agent under constant voltage of V=+8 kV, vertical electrode distance of h=15 mm, horizontal electrode distance of L=20 mm, and one round of processing with oil thickness varying between 2 mm and 8 mm in increments of 1.5 mm. The graph on the top illustrates the average water droplet size for different oil thicknesses. It can be seen that with decreasing the oil thickness, the average size of the droplets increases significantly and constantly. The increasing trend of the droplet size is uniformly positive throughout the experiments. The image on the bottom left shows a representative optical microscopy (OM) image of the emulsion formed under 8 mm of oil thickness. The image on the bottom right shows a high-resolution OM image showing water droplets as small as a couple of micrometers.

FIG. 22: A schematic representation of the cone formation and its consequent vortex flow which resists the forward motion of the liquid. Increased cone depth results in severe vortex which further resist the desired flow direction. However, the cone does not cover the whole surface of the pumping channel and many of the coalesced droplets can escape this zone with EHD forces. The numbers 1-12 show distinct steps of a cone formation. Starting from point 1, there is no deformation on the surface of the oil and as it moves forward, the deformation gets to its highest severity at point 5. After this point, the depth of the cone varies but it remains in charge of disturbing the flow throughout the process.

FIG. 23: Table 3, showing combinations of process parameters for the four different groups evaluated in this example and chances of cone formation for each distinct process parameter. This shows the impact of voltage on the average size of the water droplets (V).

FIGS. 24A-24B: Graph showing the effect of oil viscosity on water droplet size in W/O emulsions using DC (FIG. 24A), and an optical image of the formed W/O emulsion with an enlarged water droplet on the right side (FIG. 24B). With increased viscosity, the size of the water droplets increases while the uniformity decreases.

FIGS. 25A-25B: Graph showing the effect of oil viscosity on water droplet size in W/O emulsions using AC (FIG. 25A), and an optical image of the formed W/O emulsion with an enlarged water droplet on the right side (FIG. 25B). With increased viscosity, the size of the water droplets increases while the uniformity decreases.

FIGS. 26A-26B: Graph showing the effect of AC electric field frequency on water droplet size in W/O emulsions (FIG. 26A), and an optical image of the formed W/O emulsion with an enlarged water droplet on the right side (FIG. 26B). With increased frequency, the size of the water droplets decreases and the uniformity increases.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

A corona discharge is an electrical discharge caused by the ionization of a fluid such as air surrounding a conductor carrying a high voltage, seen for example as a very high electric voltage discharge from a sharp conductive edge or tip. In accordance with the present disclosure, corona discharge properties can be utilized, combining the corona discharge with the processes of electrohydrodynamic pumping in some embodiments, in order to form continuous W/O emulsions.

To generate a corona discharge, a sharp tip of a needle or a sharp edge of a blade may be used as the discharging electrode as opposed to a flat ground electrode. This configuration is also known as tip-plane configuration (or wire-plane). In this process, a high-energy electric field is made in the discharge field which ionizes the air molecules/atoms/ions and pushes them towards the ground electrode, creating an ionic wind. The air near the sharp needle/wire is ionized due to the high gradient of electric field. The approaching particles have a velocity depending on the angle of the electric field in that region and can transfer their velocity and momentum to the oil medium beneath them. As a result, the oil will tend to move forward due to the initial momentum caused by the impacting particles. Thus, electro emulsification/pumping can be induced via corona discharge. If a circular container is used for the oil medium, it can easily change the linear motion to a circulation motion. Because of the electrohydrodynamic pumping, there is no need for an external pumping and moving part. However, additional pumping apparatuses may be used to supplement the electrohydrodynamic pumping, and such uses are entirely within the scope of the present disclosure.

The oil pumping process can be combined with the addition of tiny droplets of water to the medium. The ionized particles drift toward the ground electrode, forming an ionic wind that carries the tiny water droplets towards the oil medium via electroconvection. For example, micron-sized water droplets produced by a humidifier device can be used. However, other sources of water droplets are possible and encompassed within the scope of the present disclosure. The exhaust of the humidifier can be attached to a hose and the other end of the hose can be aligned with the corona needle. Simultaneous to the corona discharge production, water vapor droplets generated by the humidifier are ionized by the electric field. After ionization, the tiny water droplets accelerate towards the oil medium due to the difference in their potential relative to the ground electrode, penetrating through the oil surface due to their momentum and charge and their attraction to the ground electrode. However, since the oil medium is in motion, the water droplets are carried away toward regions farther away from the ground electrode without deposition to the bottom of the container. The charged water droplets immerse into the oil that is pumped by the corona discharge (electrohydrodynamic pumping) via modulating the configuration of the ground electrode. The combination of both effects induced by the corona discharge leads to dispersion of the water in the oil, embedding water droplets inside, resulting in the formation of a W/O emulsion. The water droplets are effectively merged into the oil medium to form an emulsion.

This process is less viscosity dependent, and consumes significantly less energy than current emulsion formation processes. In addition, there is no limitation to the scalability of this process or the oils used as dielectrics. Even some low viscosity oils such as silicone oil 10 cSt, which is significantly volatile, have been used and shown to be completely safe. Furthermore, the noticeably high efficiency with other notable properties of the process (i.e., stability, less energy consumption, low cost of equipment, and continuous process) make it a superior method for W/O emulsion formation. W/O emulsion formation via corona discharge is a contactless method of W/O emulsion formation which enables continuous and energy-efficient production of W/O emulsions.

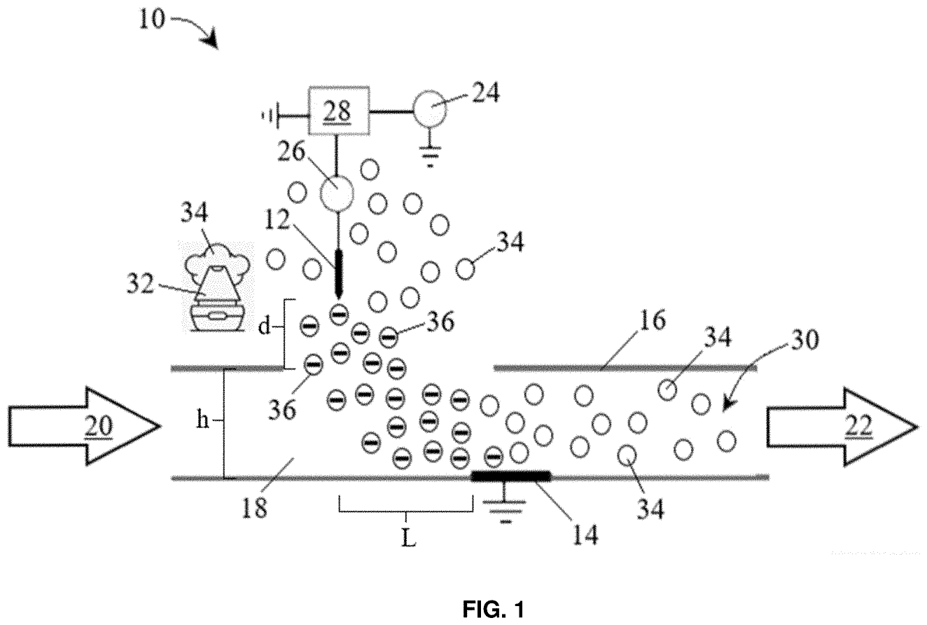

Referring now to FIG. 1, depicted is a non-limiting example system 10 for creating a W/O emulsion. The system 10 may include a corona emitting electrode 12 and a ground electrode 14, which are generally spaced a horizontal distance L apart from one another. However, in some embodiments, as discussed in more detail below, the corona emitting electrode 12 and the ground electrode 14 are not horizontally offset from one another. In other words, in some embodiments, L may be zero. L represents the closest distance between the ground electrode 14 and a position in the channel 16 directly beneath the corona emitting electrode 12. In this manner, L can be thought of a the horizontal offset between the corona emitting electrode 12 and the ground electrode 14. However, it is not strictly necessary that the channel 16 be horizontal relative to the corona emitting electrode 12, and therefore the term “horizontal offset” is used herein for exemplary purposes and is not limiting.

Referring still to FIG. 1, the ground electrode 14 may be disposed within a track or channel 16 configured to hold a first liquid phase 18 comprising an oil, and the corona emitting electrode 12 may be disposed a distance d above the surface of the first liquid phase 18 in the channel 16. The first liquid phase 18 may further include one or more surfactants. However, surfactant usage may be minimized by adjusting operating conditions. The first liquid phase 18 may have a thickness h within the channel 16, which may equal the height of the channel 16. The channel 16 may have an inlet 20 and an outlet 22, and may further include one or more valves or additional inlets or outlets. A power source 24 is configured to supply a differential voltage between the corona emitting electrode 12 and the ground electrode 14. A high voltage power supply 28 equipped with amplifier and function generator may be utilized to enhance the current 24 supplied to the corona emitting electrode 12. The ground electrode 14 is an electrically conductive material, such as a metal. In use, the ground electrode 14 is submerged in the first liquid phase 18. The first liquid phase 18 may enter the channel 16 through the inlet 20, and may exit the channel 16 through the outlet 22. The outlet 22 may be referred to as an emulsion outlet because in use, an emulsion 30 is created in the channel 16 such that the emulsion 30, not solely the first liquid phase 18, may exit through the outlet 22. An array of channels 16 may be utilized in order to provide for mass production of the emulsion 30.

Referring still to FIG. 1, the corona emitting electrode 12 is generally a sharp conductive object, such as a metal needle, and emits a corona discharge upon application of a threshold voltage. The corona discharge creates an electric field that ionizes the air particles in the space between the corona emitting electrode 12 and the first liquid phase 18 in the channel 16 (i.e., in the corona gap d). The ionized air particles are attracted to the ground electrode 14, and transfer momentum to the first liquid phase 18, causing the first liquid phase 18 to move in the direction toward the ground electrode 14. This effect is known as electrohydrodynamic pumping. The velocity of the first liquid phase 18 may be adjusted by changing the operating parameters of voltage, electrode configuration, oil viscosity, and operating frequency. The velocity of the first liquid phase 18 may be monitored by a particle image velocimetry method.

Referring still to FIG. 1, a humidifier 32 or other source of droplets of a second phase 34 comprising water may be disposed in proximity to the corona emitting electrode 12. The humidifier 32 is configured to provide water vapor in proximity to the corona emitting electrode 12. In this context, “in proximity” means close enough to the corona emitting electrode 12 such that in use, the water vapor becomes charged in the ionic wind created by the corona discharge from the corona emitting electrode 12. The humidifier 32 may be used to generate droplets of the second phase 34 that become ionized water droplets 36 in the electric field created by the corona discharge emitted from the corona emitting electrode 12. The ionized water droplets 36 are also attracted to the ground electrode 14. However, because of the motion of the first liquid phase 18 from the electrohydrodynamic pumping, instead of settling at the bottom of the first liquid phase 18, the ionized water droplets 36 are carried away and dispersed in the first liquid phase 18, creating an emulsion 30 of the second phase 34 in the first liquid phase 18 (i.e., a W/O emulsion). The emulsion 30 can be collected, for instance by flowing through the outlet 22 into a desired container or location. The process can be made continuous by, for example, continuously introducing first liquid phase 18 into the inlet 20, continuously introducing charged droplets into the first liquid phase 18 through the humidifier 32 and corona discharge from the corona emitting electrode 12, and continuously collecting emulsion 30 through the outlet 22.

Referring still to FIG. 1, in some embodiments, L is at least equal to or greater than 2.15*d(tan(65)*d) in order to guarantee that electroconvective motion is triggered, where d is the corona gap (i.e., the distance between the corona emitting electrode 12 and the first liquid phase 18). The corona gap d should not have a very small value. Rather, the corona gap d should be selected in a way that the discharge starts and remains in the Townsend regime. The differential voltage between the corona emitting electrode 12 and the ground electrode 14 is the discharge voltage, and for negative corona discharge and room conditions (NTP) should be at least 3 kV. The voltage may be adjusted in such a way that the thickness h of the first liquid phase 18 remains constant during the operation and keeps the thickness h in stable/unstable boundary conditions, outside of which the surface of the first liquid phase 18 may deform. By increasing the continuous phase conductivity (a), the values of L and d, as well as the voltage, may be adjusted in a way that causes no extensive conduction current to be observed and ensures the discharge current 24 remains in the Townsend regime.

The relative humidity may be adjusted to at least 85% for best performance. However, forming an emulsion is possible with a smaller relative humidity, though it may result in poor performance. The shape of the ground electrode 14 may also be adjusted or customized based on the geometry of the channel 16 and the fluid condition in a way that leaves vortex flow observed. Furthermore, different configurations are possible, as described in more detail below.

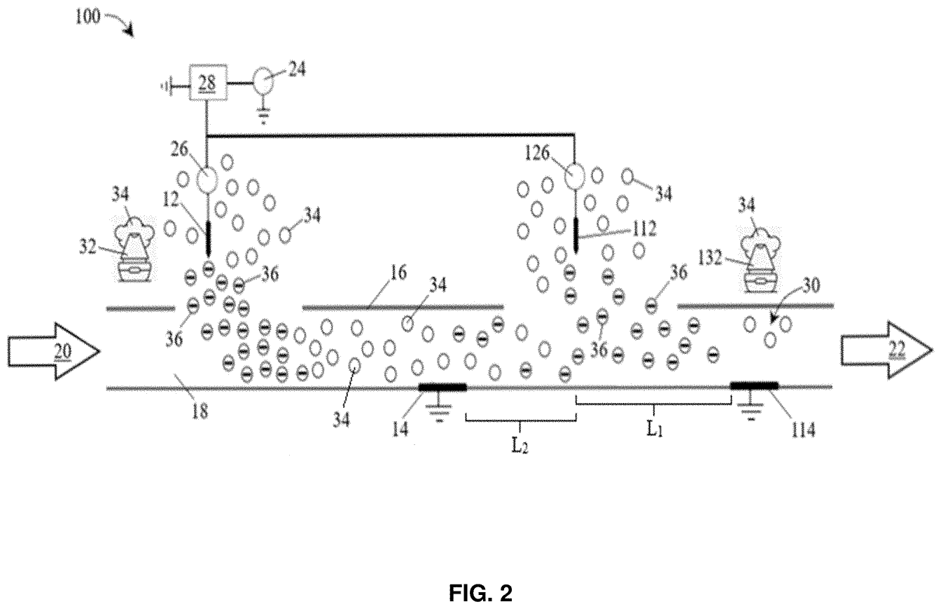

Referring now to FIG. 2, depicted is a non-limiting example system 100 for creating a W/O emulsion 30 where the system 100 includes a second corona emitting electrode 112 and a second ground electrode 114 in the channel 16 between the inlet 20 and the outlet 22. The system 100 may optionally include a second humidifier 132 in proximity to the second corona emitting electrode 112. However, it is not necessary to have a second humidifier 132. The second corona emitting electrode 112 may be powered by the same power source 28 as the first corona emitting electrode 26, as depicted in FIG. 2, or may alternatively be powered by an additional power source. The number of power sources is not particularly limited.

With multiple corona emitting electrodes 12, 112 and multiple ground electrodes 14, 114, the distance L₁ between the second corona emitting electrode 112 and the second ground electrode 114 should be less than the distance L₂ between the first ground electrode 14 and the second corona emitting electrode 112 for effective electrohydrodynamic pumping. L₂ should be greater than L₁. L₁ should be lesser than L₂. However, embodiments in which L₁ is greater than L₂ are nonetheless encompassed within the scope of the present disclosure, for example because relative motion between the corona emitting electrodes 12, 112 and the first liquid phase 18 may be created through other means, such as by mechanically moving the corona emitting electrodes 12, 112 and/or the first liquid phase 18.

Further embodiments of systems for creating an emulsion may include three or more sets of corona emitting electrodes and ground electrodes. The number of sets of corona emitting electrodes and ground electrodes is not particularly limited.

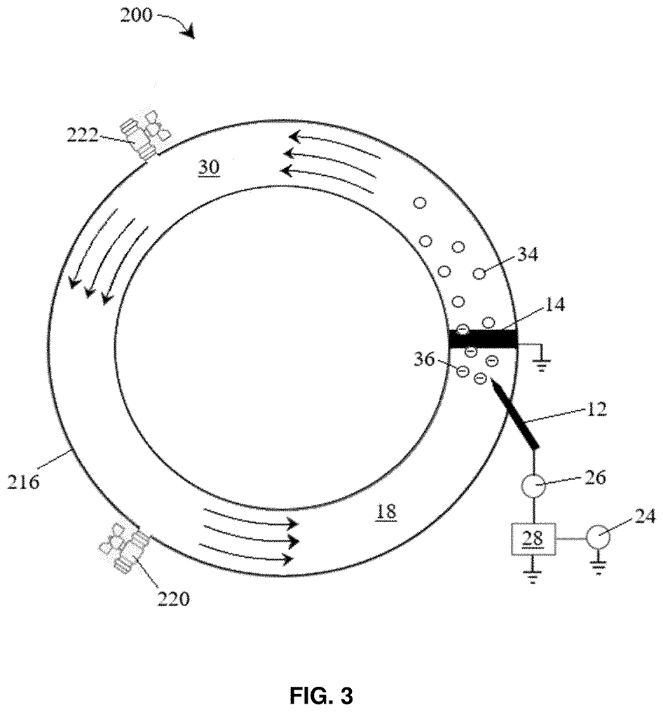

Referring now to FIG. 3, depicted is a non-limiting example system 200 for creating a W/O emulsion, where the system 200 includes a circular channel 216. As noted above, the linear motion created by the electrohydrodynamic pumping is easily converted into a circulation motion. The system 200 may include an inlet valve 220, where the first liquid phase 18 comprising an oil can be introduced to the channel 216, and an outlet valve 222, where the emulsion 30 can be removed from the channel. The inlet valve 220 and outlet valve 222 may be operated so as to control the concentration of the emulsion 30. For example, the first liquid phase 18 may be introduced through the inlet valve 220, then both the inlet valve 220 and the outlet valve 222 may be kept closed for a period of time while the corona emitting electrode 12 produces ionized droplets 36 that are then dispersed in the first liquid phase 18 by the electrohydrodynamic pumping, for a period of time sufficient to reach a desired concentration of the second phase 23 in the first liquid phase 18. Upon reaching the desired emulsion concentration, the outlet valve 222 may be opened to collect the emulsion 30. Alternatively, the system 200 may be used in a continuous process, where the first liquid phase 18 is continuously introduced through the inlet valve 220 while emulsion 30 is continuously recovered through the outlet valve 222.

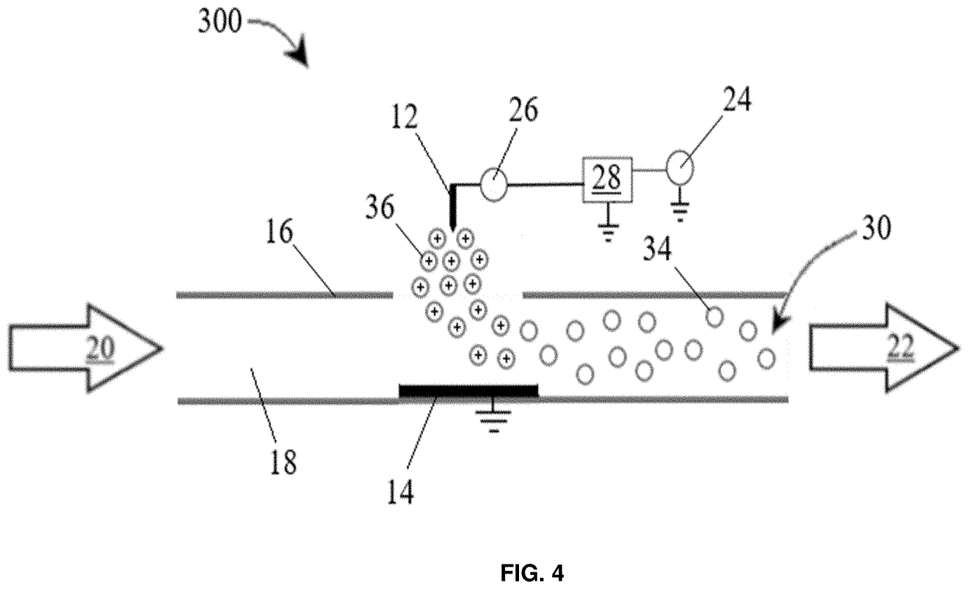

Referring now to FIG. 4, depicted is a system 300 for creating an emulsion where the ground electrode 14 is not horizontally offset from the corona emitting electrode 12. Rather, an external flow can be applied through the inlet 20 so as to create movement of the first liquid phase 18 comprising an oil in the channel 16 relative to the corona emitting electrode 12, such as movement in the direction of toward the outlet 22, thereby dispersing the ionized droplets 36 in the first liquid phase 18 and creating a W/O emulsion 30 that can be collected at the outlet 22.

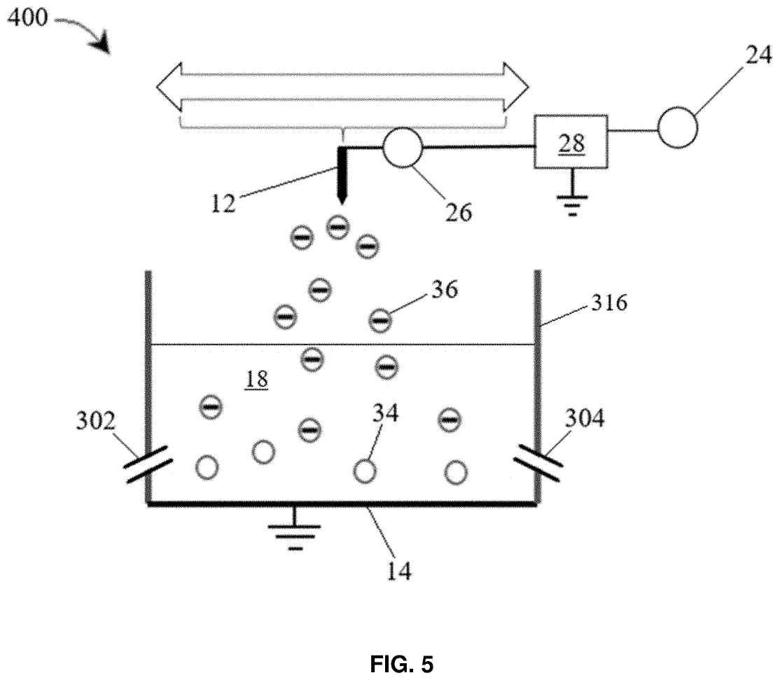

Referring now to FIG. 5, depicted is a system 400 for creating a W/O emulsion where the corona emitting electrode 12 is movable relative to the ground electrode 14. In such a system 400, the first liquid phase 18 comprising an oil may be either stable (i.e., not moving) in the channel 316, or may be under an external flow as described above. If the first liquid phase 18 is stable, the channel 316 may simply be any reservoir or container for holding the first liquid phase 18. The corona emitting electrode 12 may be moved relative to the ground electrode 14 as depicted by the double-sided arrow in FIG. 5. In this manner, the relative motion enables the ionized droplets 36 of water to be dispersed within the first liquid phase 18 to create a W/O emulsion 30. The channel 316 may be a container, where the first liquid phase 18 may be introduced into the channel 318 through an inlet valve 302, and the emulsion 30 may be collected from the channel 316 through an outlet valve 304. In other embodiments, a single valve may serve as both the inlet valve 302 and the outlet valve 304, since movement of the first liquid phase 18 is not necessary when the corona emitting electrode 12 is movable relative to the ground electrode 14.

The systems and methods described herein are advantageous for producing W/O emulsions useful in a wide variety of applications. Advantageously, the systems and methods can be contactless, which provides safety benefits. There is no external temperature or pressure that need to be applied. The systems and methods may require only a low energy consumption (e.g., 1300 W/Kg). The systems and methods may be implemented in a continuous process. Furthermore, the emulsion formation is effective independent from liquid viscosity levels. Additionally, less concentration of emulsifier agents than conventional methods is required, and the systems and methods can produce increased emulsion stability in a scalable process with a low cost of equipment and maintenance and no moving parts necessary (though, as described above, in some embodiments, the corona emitting electrode may be moved instead of, or in addition to, the first liquid phase).

### EXAMPLES

### Example I

Forming emulsions has been a challenging task, especially for mediums with high viscosity. In conventional methods, it is needed to overcome the shear stress of the continuous phase in order to disrupt the dispersed phase droplets. Up to now, many high- and low-energy methods have been utilized in order to make emulsions. Here, a bottom-up method of W/O emulsion formation is demonstrated using a contact-less corona discharge applicable to wide range of emulsions (e.g., macro, nano, and micro emulsions). The corona discharge creates an ionic wind (electroconvection) that drags water vapor droplets, created by a humidifier, into an oil medium. The corona discharge also induces motion of the oil medium via an electrohydrodynamic (EHD) pumping effect using a modulated bottom electrode geometry. By these two effects, this contact-less method enables immersion of the water droplets into the moving oil medium continuously forming a water-in-oil (W/O) emulsion. This method does not require high power and/or an excessive amount of surfactant. The medium used in this example was silicone oil in different viscosities. The impacts of oil viscosity on the properties of the created emulsion and the power consumption of the process were studied. This is a low-cost, contact-less, and power-efficient process enabling continuous formation of emulsions with varying oil viscosities.

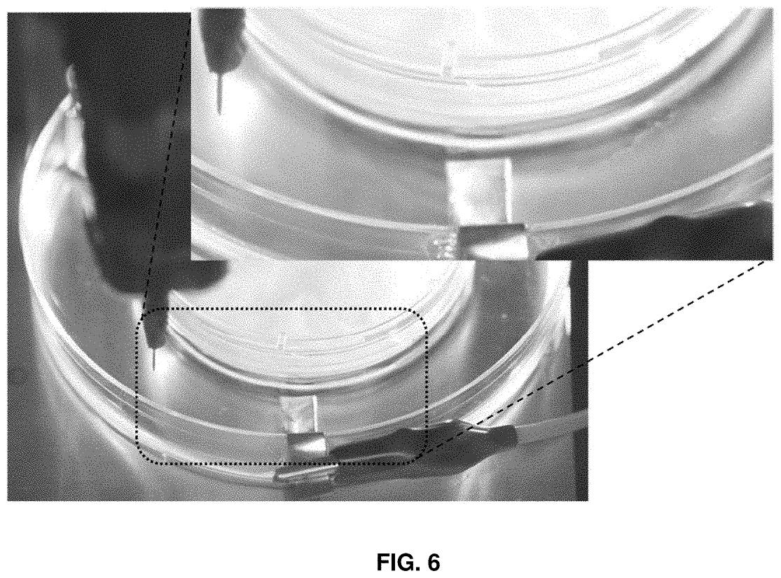

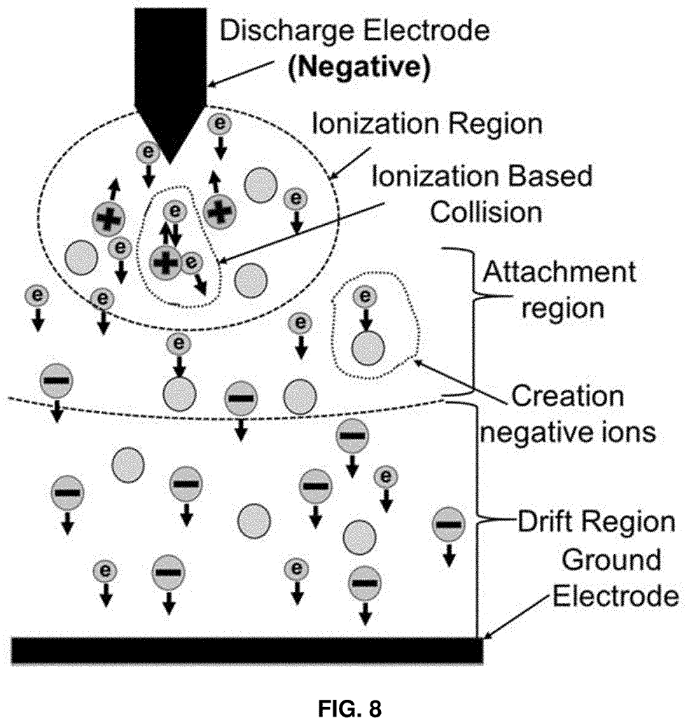

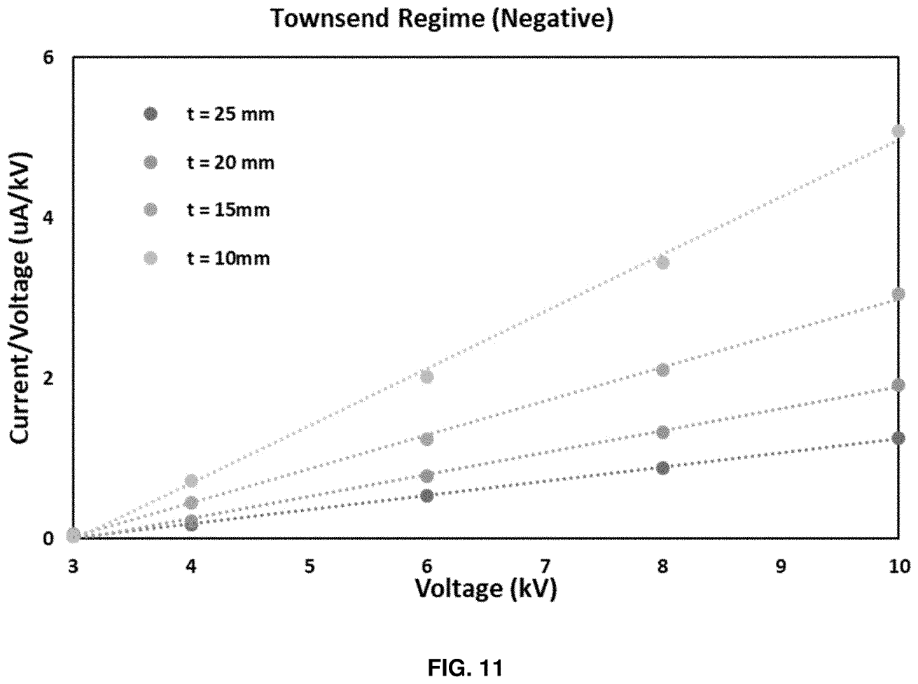

In this example, a non-uniform electric field was created using a corona discharge to form micro/nano W/O emulsions with varying oil viscosities via a continuous and power-efficient process. A pin-to-plate (which can be extended to multiple electrode and wire-to-plate configurations, as described above) was built for forming the non-uniform electric field via negative corona discharge. FIGS. 6, 10 show photographs of this system. The negative corona discharge ionizes the air molecules around the pin (discharge zone), forming an ionic wind that carries water droplets (formed by a humidifier) towards a silicone oil medium. This is illustrated in FIG. 8. A ground electrode (plate) was placed inside the oil medium, leading to oil circulation via an electrohydrodynamic pumping. The electroconvective driven water droplets drift toward the circulating oil and immerse into it, continuously forming a W/O emulsion. The offset of the ground electrode to the surface beneath the ionizing electrode was engineered to obtain a desired motion of the continuous phase (i.e., silicone oil) for efficient emulsion formation, though, as described above, this is not strictly necessary because relative motion of the liquid can be generated through other methods. The charged water droplets vary in sizes (from nano to micro) based on the type of utilized humidifier, leading to formation of micro to macro W/O emulsions. This example demonstrates a contact-less, continuous, and power-efficient method for the production of W/O emulsions applicable in, for example, cosmetic, drug delivery, and food industries.

Materials and Methods

FIG. 1 shows a schematic of the electroemulsification method induced by the corona discharge. The setup included a sharp tip/wire (pin), narrow channel, ground electrode (plate), and continuous phase fluid (i.e., silicone oil). The ground electrode was installed in the bottom of the container with an adjustable position. This offset can create horizontal movement on the oil as an effect of the collision between ions (created by the sharp electrode) and the oil surface, so-called electrohydrodynamic (EHD) pumping. In order to investigate the EHD pumping in a laboratory environment and to eliminate the effect of other mechanical variables, a circular shape closed-loop setup was designed to conduct the experiments, illustrated in FIG. 3. A high-voltage generating system tied to a super fine tungsten needle was used as a corona-generating electrode. A DSLR camera (Nikon D5500) was remotely operated to take a video of the top view of the liquid surface during the tests. Voltages and currents were actively monitored and recorded using the built-in measurement system of the TREK amplifier coupled to a Keithley 2100 digital multimeter. The high-voltage system utilized a ±10 kV TREK Model 10/10B high-voltage amplifier connected to a bench-top function generator (SDG 1032X) that was capable of providing different waveforms and frequencies, but only negative voltages were used for the results presented in this example. The materials used in this example were mainly deionized water (Sigma-Aldrich) and silicone oil with different viscosities (HUDY). The setup was filled up to h=10 mm silicone oil with viscosity of 100, 200, and 350 cSt. With the help of a laboratory jack, the gap between the corona generating electrode (sharp tungsten needle) and the top surface of the oil in the pump was kept constant to a specific distance. Advantageous gap distances can be calculated by considering the current density distribution on the oil surface, which is defined by Warburg's law:

$$j = \frac{{I}_{c}}{2 {t}^{2}} {( cos ( α ) )}^{n} \{ \begin{matrix}\begin{matrix}n = 4.82 & Positive Corona \\ n = 4.65 & Negative Corona\end{matrix} \\ α \leq 60 °\end{matrix} \qquad ( 1 )$$

where I_{c} is the corona current, t is the corona gap, α is the angle between the needle and a point on the surface, and n is a constant. The current density distribution in a point on the surface reaches zero when the angle between the point and the needle axis reaches 65 degree. The pump was composed of two concentrically attached glass petri dishes with outside diameters (OD) of 60 and 90 mm. With this configuration, a circular channel was formed with a width of 25 mm. In order to cover the whole width of the channel with the ionic wind, the distance of the needle tip to the oil surface was set to d=6 mm. In addition, the ground electrode should be out of this area to make sure that no vertical impact takes place by the ionized water droplets. In this way, all the water droplets have velocity in the oil surface direction. This configuration prevents charge trapping by vertical charge injection as well as lack of momentum by horizontal charge injection. Due to these considerations, the ground electrode was kept as I=12 mm.

Another thing to be considered is the applied voltage to the EHD pumping setup. If the applied voltage is lower than that of corona onset voltage, there is no discharge occurring during the process. According to the Townsend's discharge regime, the current is proportional to the square of the applied voltage and the corona onset voltage can be found by the experimental results:

$$\frac{I}{V} = k ( V - {V}_{0} ) \qquad ( 2 )$$

where k is a constant and V₀ is the corona onset voltage. FIG. 11 shows negative corona discharge with different electrode configurations (changed t values from 10 to 25 mm). In all cases, the corona onset voltage was found to be 3 kV. In general, the higher applied voltage corresponded to higher current and stronger discharge regime. The most applicable way to control the pump discharge flowrate is to manipulate applied voltage. The electric wind velocity in corona discharge can be calculated by:

$$v = M \sqrt{\frac{R . I}{μ}} \qquad ( 3 )$$

where R is the distance between the electrodes, μ is the ion mobility, and M is a constant. According to this equation, the higher current is correlated to the higher velocity of the impacting water droplets and higher pump performance However, higher current increases the number of ions in the space charge and built-up trapped charge on the oil surface, and consequently increases the electrostatic pressure, causing a cone formation which results in a vortex flow between the needle and the ground electrode. Based on the limitations of the high and low voltages in the processing and by applying ramp waveform from 0 to 8.5 kV, an advantageous operating voltage was experimentally found to be exactly 6.5 kV. However, this voltage may differ based on different setup geometry, oil level, and oil properties.

In order to control the processing parameters (i.e., relative humidity, needle distance to the oil surface, imaging, etc.), a customized chamber with controlled atmosphere was utilized. The humidity was provided by a typical home humidifier and the relative humidity was constantly kept at 87-90%, during the whole experiment. Also, in order to prevent the accumulation and excessive condensation of tiny water droplets, the whole emulsion formation setup was kept at 100 mm from the bottom of the chamber and out of the direct flow of the humidifier.

The emulsion samples were made by applying voltage for 5 minutes for each batch with different silicone oil viscosities of 100, 200, and 350 cSt, and 100 mM Span 80 as the surfactant. The processed samples were weighed and then collected into separate quartz cuvettes (10×10×45 mm) for characterization purposes. The prepared batches were then analyzed under automated optical microscope for measuring the droplet sizes and their distribution (Keyence VHX-600 digital microscope, magnification of 20×-2000×). Finally, using the MIPAR software package, a proper recipe was prepared for calculating the number and the size of the droplets from the captured images. The water droplets size created by the humidifier was measured by a phase doppler anemometer capable measuring droplets ranging of 0.3 to 10 μm. The results of image processing and the experimental observations were in a strong accordance.

Results

In the ion-drag pump, electrohydrodynamic (EHD) force is produced by the interaction of electrical fields and free charges in an insulating fluid medium. Pumping is achieved if the electrical shear stresses are higher than the viscous shear stress. Therefore, EHD pumping is a phenomenon that has two basic requirements. First, the dielectric fluid being pumped should contain free charges. Second, an electric field should be present to interact with the free charges in the fluid. Free charges are established in the fluid medium by direct injection from a corona source. An electric field is established between the sharp tip (pin) and the ground electrode (plate). This electric field drags the free charges through the field, thus setting the fluid in motion. These EHD pumps are known as ion-drag pumps. In general, the EHD ion drag pumping depends on the electrical current, the applied voltage, and the electrode geometry. The flow of this EHD pumping can be manipulated by either power supply voltage or distance between the bottom of the ionizing electrode and the closest side of the ground electrode. In the corona discharge fields of pumping section, it was believed that ionic wind as gas-phase EHD flow would be blown along the gas-liquid interface from the emitter electrode toward the collector (ground) electrode. However, the ionic wind improved the liquid pumping due to an interfacial momentum transfer effect along the gas-liquid interface.

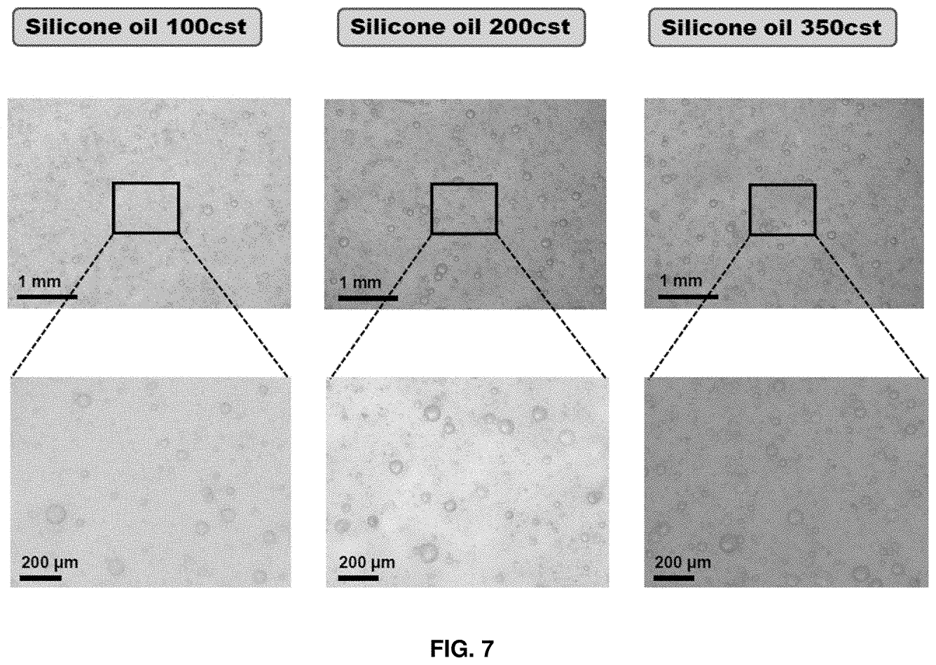

The prepared emulsion samples were collected separately into different quartz cuvettes in order to do optical microscopy for observing the water droplet sizes in the emulsions. In all the samples, under different magnifications, a significant number of water droplets was observed, which is in agreement with the weighted samples having ˜2 wt. % of added water content (FIG. 7, top). In addition to this, the size distribution of the water droplets under higher magnification (FIG. 7, bottom) shows significantly smaller droplets which were not apparent under an optical microscope. Without wishing to be bound by theory, it is believed that the droplet size distribution in the droplet is the same as the size distribution of the water droplets made by the humidifier. The size distribution and water droplet uniformity in all samples with different oil viscosities are nearly similar, which shows that the process is independent of the oil viscosity. FIG. 7 clearly shows that the emulsion samples were made successfully, considering the stable water droplets inside the oil medium. Regardless of the oil viscosity, the emulsion samples show the presence of the water droplets in different sizes. This proves that the processing recipe may be applied to different mediums with different viscosities. On the other hand, the distribution of the droplets throughout the imaging areas of all samples shows that the water droplets existed uniformly in different locations. This finding demonstrates that the pumping process is efficient since the samples were collected from different levels of oil from different regions of the pump surface. The reason for slightly higher water content in the lower oil viscosity reflects the fact that the pumping process was more easily done for the silicone oil 100 cSt due to higher electroconvection flow.

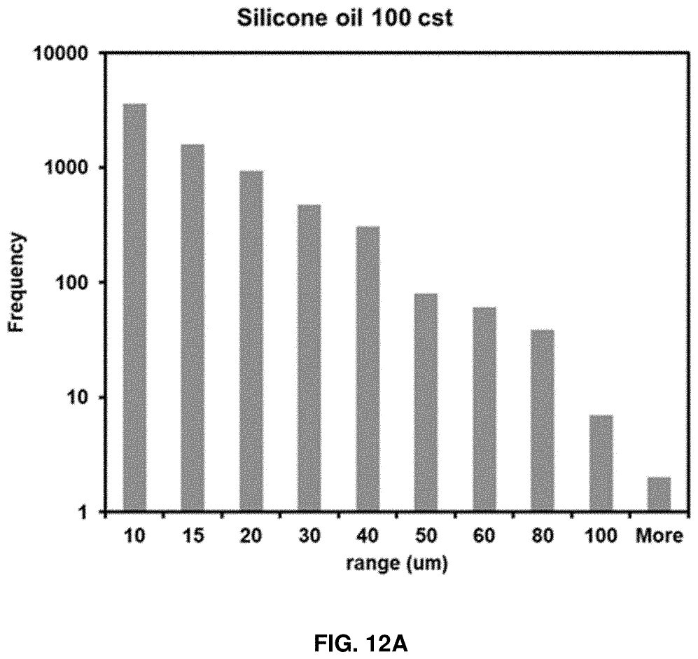

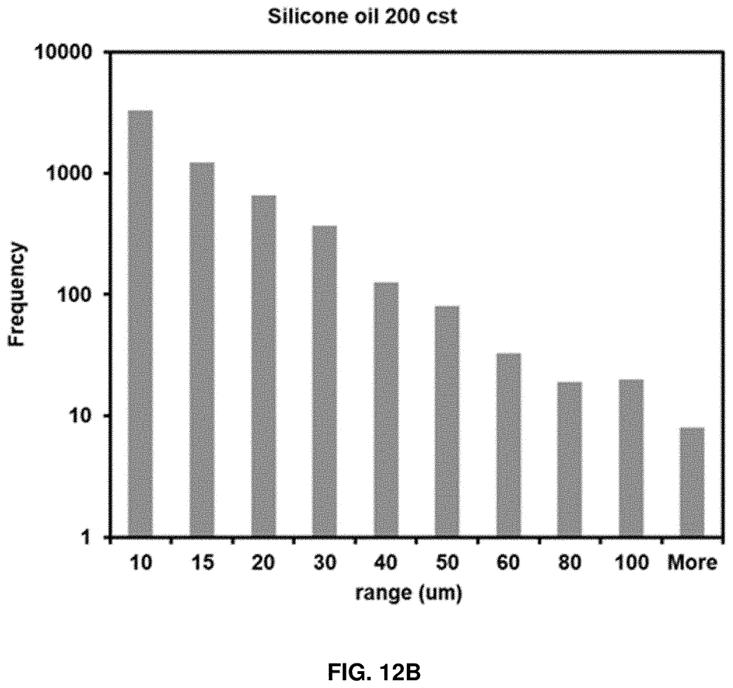

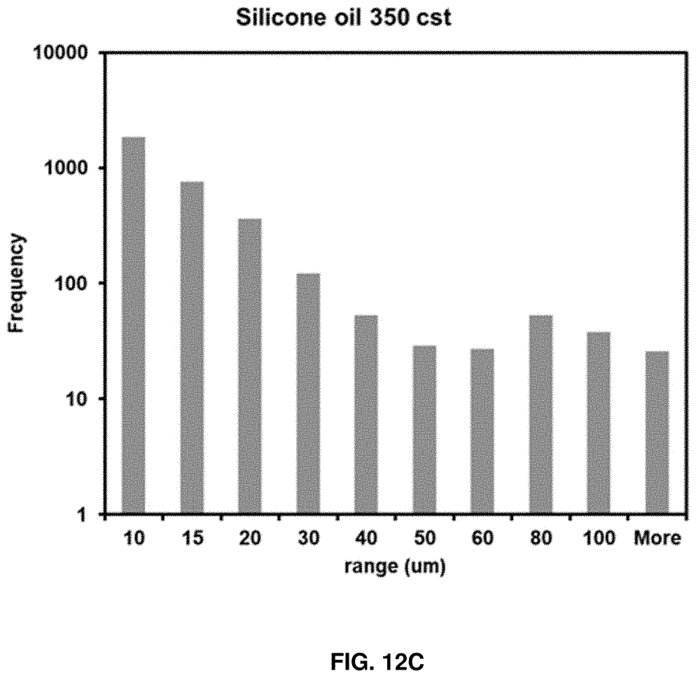

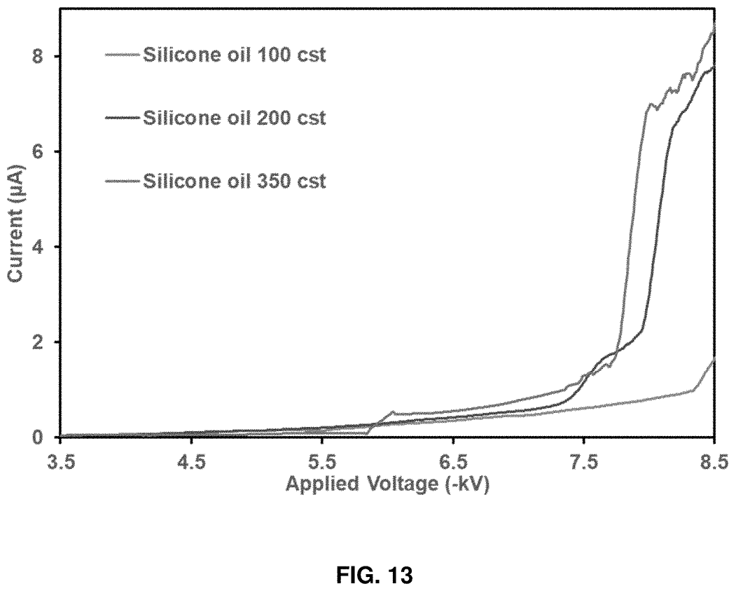

As it can be seen from the size distribution graphs in FIGS. 12A-12C, all the samples have relatively similar trend in size distribution of the water droplet size inside the emulsions. However, by increasing the viscosity of the silicone oil to 350 cSt, the size of the water droplets slightly increased. In this viscosity, a coalescence happens around the ground electrode due to lower electroconvection motion and water droplets having enough time to get closer and coalesce. This indicates that the most advantageous geometry of the ground electrode may vary based on the liquid properties, processing conditions, and the electric field applied to the medium to reduce coalescence rate.

FIG. 11 shows the current consumed by EHD pump as the response to ramp input (0˜8.5 kV) with different oil viscosities under the same processing conditions (i.e., processing time, applied voltage, needle distance to the oil surface, etc.). As can be seen in FIG. 11, the highest current consumption goes to the sample with the highest viscosity. The reason is that higher viscosities correspond to the lower ion mobility which is the same as lower electroconvection flow and, subsequently, fewer charge carriers can pass the distance between electrodes and are trapped on the oil surface. The trapped charge builds electrostatic pressure and deforms the surface, causing lower oil thickness in the area close to the ground electrode. This phenomenon creates short passage with lower electrical resistance, resulting in a significant portion of charges being transferred through conduction rather than electroconvection. FIG. 12A shows surface deformation of different oil viscosity at 6.5 kV applied voltage. In the highest applied voltage (8.5 kV) and higher viscosity, the charges can penetrate the surface, opening a direct path to the ground electrode (FIG. 12C). The effect of decreasing resistance was directly related to the number of transferred charge and the consumed current, which is in direct relation with the consumed power.

Table 1 shows the power consumed during the process with different oil viscosity. In the next step, the corresponding power density of each sample with different viscosity is calculated. In order to do so, the prepared emulsions were weighed after processing and compared to the reference weight of each 10 g batch before processing. The additional weight to the oil medium shows the final mass of each sample. By dividing the weight of each batch after emulsification process, the current density is found. As can be seen from Table 1, the highest power density is found to be for the sample with the highest viscosity (358 mW/kg). The power density calculated for these samples is significantly lower than that of the emulsions formed via high-energy (10⁸˜10¹⁰ W/kg) and low-energy (10³˜10⁵ W/kg) emulsification methods, even by considering the power of the external source of humidity (according to the Department of Energy, the average power of a portable cool mist generator is 85 Watts).

TABLE 1
Power consumption for emulsion formation
using silicone oil with different viscosities

| | | | |
|---|---|---|---|
| Oil vicosity (cst) | 100 | 200 | 350 |
| Power (mW) | 2.3 | 2.7 | 3.6 |
| Power density (mW/Kg) | 229.2 | 273.6 | 358.5 |

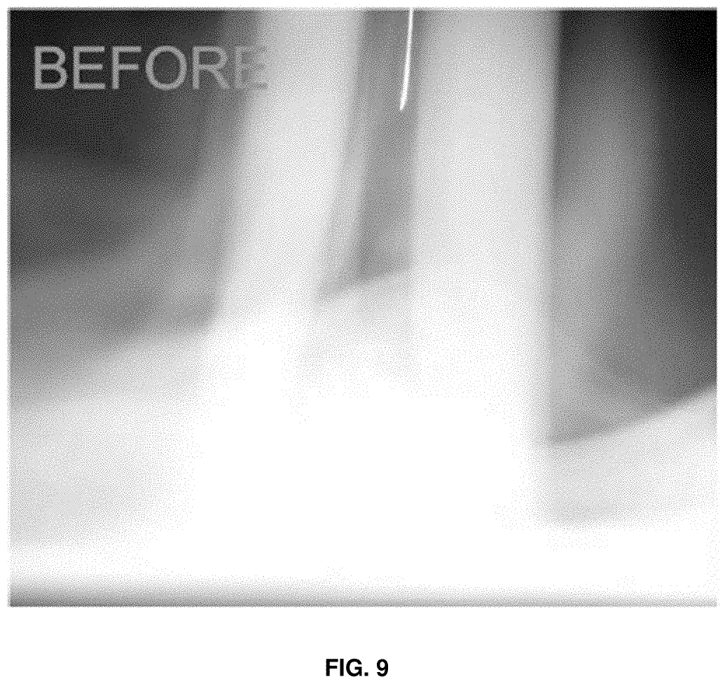

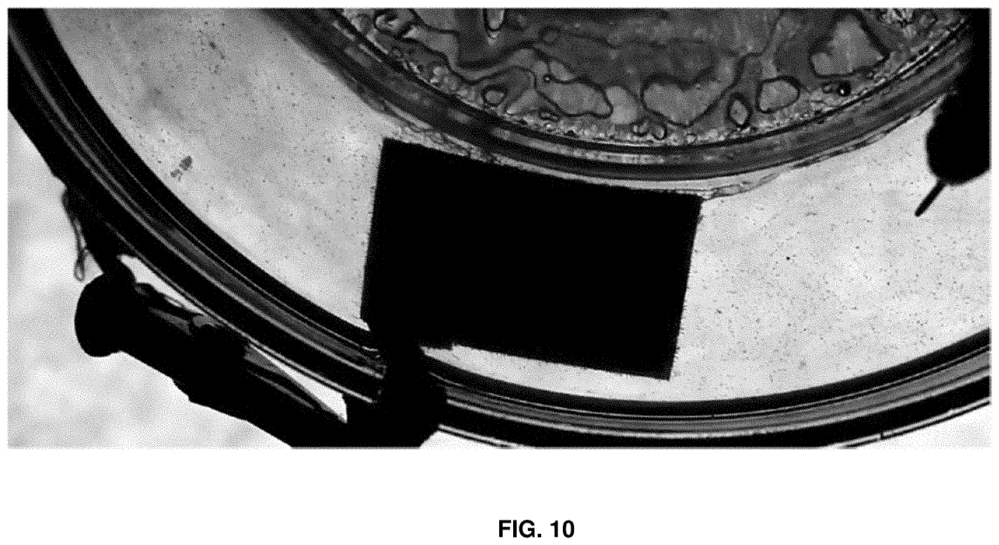

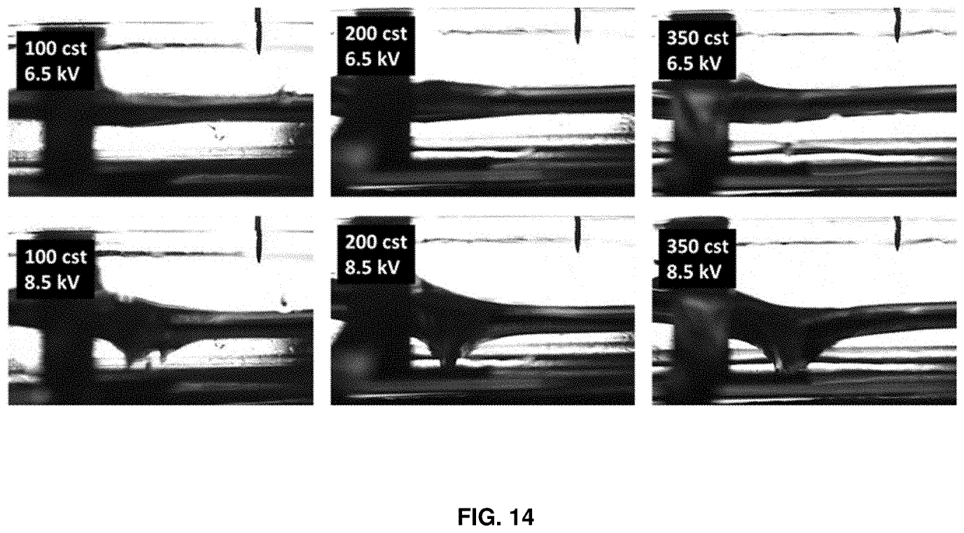

FIG. 9 shows a photograph of water droplet manipulation during formation of W/O emulsions via corona discharge, and FIG. 14 shows cross-section images of the silicone oil deformation under the corona discharge.

Conclusion

The W/O emulsion formation method demonstrated in this example is a bottom-up approach for preparing W/O emulsions with a controllable water content. Despite all the conventionally available emulsion formation methods, the droplets are first made externally regardless of the limitation introduced by the continuous phase (overcoming the shear stress or chemical composition). In the next step, the droplets are impinged into the oil medium via acquired acceleration and velocity from electrical charging. Simultaneously, the droplets create a pumping feature inside the continuous phase which provides continuous emulsion formation. Continuous emulsion formation makes it possible to have real-time control of the emulsion formation process. In addition, the method eliminates the negative effects of external pressure and temperature that exist in commercially available processes on sensitive applications. At the same time, required use of any type of moving parts is eliminated as well, which results in a cleaner product without introducing erosion by-product to the final product. Furthermore, some charge residue may remain in the emulsion, which can increase the stability of the emulsion and, consequently, require a lesser concentration of emulsifier agents. Finally, the energy consumption of this process is significantly less than other widely used methods of emulsion formation. Combined with its scalability and low initial cost and life cycle cost, this method is a viable alternative to the other W/O emulsion formation processes in different industrial sectors.

### Example II

Electroemulsification methods are a capable means of emulsion formation which utilize the electrohydrodynamic forces to manipulate fluids and droplets. These forces change the morphology of the fluid surface upon impacting and cause different types of deformations. In this example, a corona discharge system was used to simultaneously form W/O emulsions and pump the products out of the electric field region without any contact between the discharging electrode and the dielectric medium. A homestyle humidifier was utilized in order to produce the tiny water droplets as the dispersant phase. The major contributing process parameters are identified as the voltage of the corona discharge, the vertical and horizontal distances between the two electrodes, and the depth of silicone oil as the continuous phase of the emulsions. These elements were experimentally analyzed in order to reveal their actual effects on the efficiency of emulsion formation and the physics behind different phenomena taking place during the injection of charged water droplets into silicone oil. The trend in the size change of the water droplets in the final emulsions is illustrated. It is shown that these process parameters are all in effect mutually and there are a variety of combinations that can result in the same emulsion characteristics.

A contactless configuration of electroemulsification setup which simultaneously makes W/O emulsions with corona discharge charge injection and pumps the product out of the range of electric field with electrohydrodynamic pumping (EHD) to reduce the rate of electrocoalescence was developed. Corona discharge is in the family of cold plasma discharges which takes place while discharge occurs between a pointing electrode and a plane one. The color of corona discharge can be visible in special conditions of lighting and it ranges from a dark blue to a very light and difficult to see pale blue. Different applications of corona discharges have been explored in the literature from which ion thrusters, water treatment, and scar treatment are the most investigated ones. In this example, the effects of different working parameters, namely, voltage (V), vertical distance of the sharp needle tip to the oil surface (h), horizontal distance of the needle tip to the start of the copper ground electrode (L), and the depth of the silicone oil (t), on the rate of emulsification and change in the size of water droplets in the W/O emulsion were investigated. Although there are many different configurations for non-uniform electric field generation, the pin-to-plate setup was selected since it has been widely used and it does not have specific mechanical constraints or processing limits (e.g., Joule heating, etc.). In order to demonstrate the direct effect of these parameters on the quality of emulsion formation, the size ranges of the droplets were measured via optical microscopy followed by numerical image processing using Python and ImageJ.

Materials and Methods

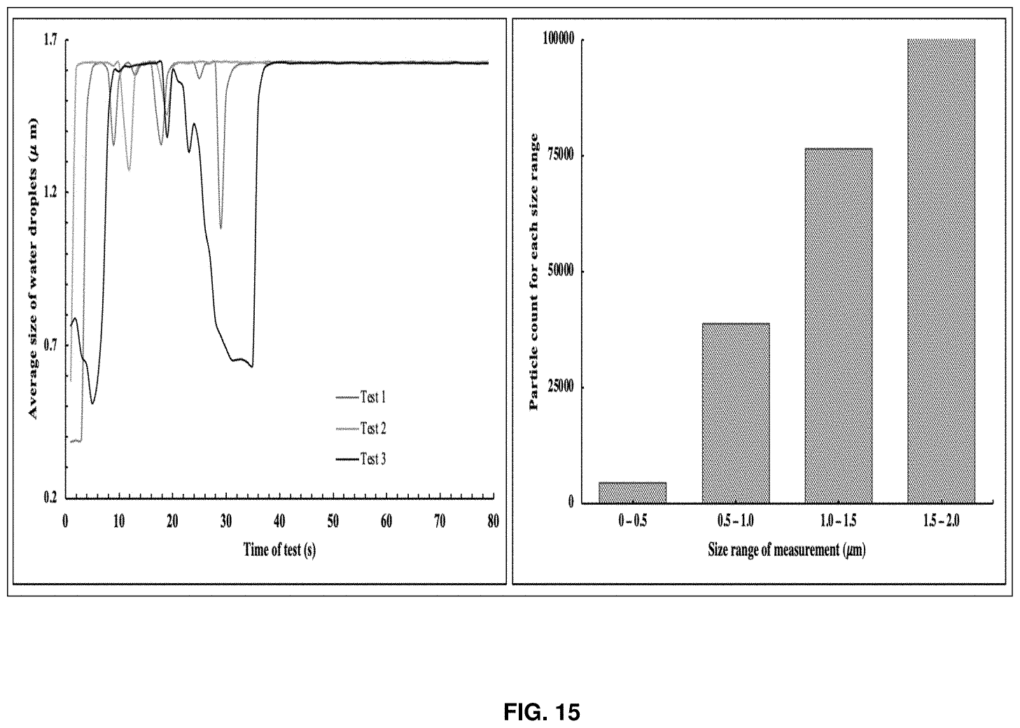

The effect of different processing parameters on the size of water droplets injected into a silicone oil medium via corona discharge was investigated. In order to conduct the experiments, silicone oil with a kinematic viscosity of 100 cSt (μ MicroLubrol, Clifton, N.J., USA) was used for all the experiments to cancel the effect of different oil viscosity on the results. The properties of the silicone oil used in this example are presented in Error! Reference source not found. To enhance the process of emulsion formation, 1 wt. % Span 80 surfactant (Sigma Aldrich, St. Louis, Mo., USA) was added to the silicone oil medium. After addition of the surfactant, the product was shaken gently and then it was mixed ultrasonically with a digital ultrasonic cleaner (Vevor, Los Angeles, Calif., USA) for three rounds of 15 minutes with 30-minute intervals to allow sufficient cooling. The high potential required for formation of a corona discharge was provided by a power supply (Siglent, Solon, Ohio, USA) which is capable of producing up to 1000V in both alternating and direct current modes (AC and DC). The output potential of the power supply was then entered to a high-voltage amplifier (Advanced Energy, Lockport, N.Y., USA) in order to get a 10× output. Throughout the experiments, the electrical characteristics of the process were controlled with the same function generator. A sharp tungsten needle was added to the high-voltage end of the power supply countered by a grounded copper tape in order to form a corona discharge in the region between the two electrodes. The vertical and horizontal distances of the needle tip to the top of the oil surface and the start of the grounded copper electrode, respectively, were measured carefully using a set of markings and fixed steel gauges. In order to measure the height of the silicone oil in the petri dish, the mass of the added oil was measured using a precision digital scale (US Solid, Cleveland, Ohio, USA). Knowing the density of the silicone oil, the mass was then converted into the height of the liquid for each experiment. After setting up the equipment, a homestyle humidifier (Honeywell, Charlotte, N.C., USA) was utilized as the source of tiny water droplets in the form of water vapor. As can be seen in FIG. 15, the size of the water droplets provided by the humidifier was approximately 1.62 μm. The output humidity of the humidifier was connected to a tube in line with the sharp tungsten needle in order to ionize the water droplets at the moment the electric field was applied. Using an environmental particulate matter sensor SPS30 (Sensirion, Staefa, Switzerland), with a lower limit detection of 0.3 μm, the water droplet size was measured prior to applying the electric field.

The pumping container was made of two clear petri dishes connected concentrically via instant glue in order to make a circular channel which guided the raw and processed materials through. The reason for using the circular pump was to let the intact silicone oil enter from one side and the final emulsion product exit from the other side. In addition, this setup helps to circulate the fluid in the discharge region and prevents any unwanted electrocoalescence on the water droplets. In a stationary configuration, the stabilized water droplets under the discharge get trapped and consume the newly-added droplets and consequently form a larger one, which is not desired. In order to have a uniform processing time between different experiments, a processing time equal to the time consumed for the fastest circulation was set for all of the experimental combinations. In the case of this example, the time of one round of circulation was measured by adding alumina particles to the raw oil and letting it circulate a complete round, which was measured to be approximately 53 seconds. This time was then set to be the base of conducting all the other experiments. However, in lower velocity samples (depending on the combination of the processing parameters), the considered time was not sufficient to achieve emulsion formation in the whole volume of the silicone oil. As a result, the scheme of the experiments was changed to let each sample pass one complete round of circulation. FIG. 1 shows a schematic illustration of the setup after all the components were connected.

TABLE 2
Nominal properties of the silicone oil used in
the electroemulsification experiments

| | Density | | Electrical | Surface | Relative |
|---|---|---|---|---|---|
| | ρ | Viscosity | conductivity | tension γ | permittivity |
| Material | (g/cm³) | μ (cSt) | σ (S/m) | (mN/m) | ∈ |
| Silicone | 0.964 | 100 | 1 × 10⁻¹³ | 20.9 | 2.73 |
| Oil | | | | | |
| Water | 0.996 | 1 | 0.0016 | 72.8 | 80.1 |

Since some of the samples were circulating slower compared to the fastest one, they did not pass one complete round of circulation at the given time and as a result, some portions of the silicone oil in those samples were not treated with corona injection. In order to cancel the negative effect of collecting untreated samples on the average size of the droplets, oil portions were manually collected from four different spots, both from top and bottom of the product fluid, with a pipet. Then the samples were transferred to a glass vial and were prepared for optical microscopy on quartz microscope glass slides. The process of imaging was done using a digital microscope (Keyence Corporation of America, Itasca, Ill., USA). After imaging, the raw digital files were deployed to ImageJ to get binary output of the droplets detected in the field of view. Using the imaging scale bar and the size of the pixels in each binary image, the size of the droplets was calculated using a Python script. The average sizes of the water droplets were calculated seven times for each sample in order to have the highest level of certainty in the results.

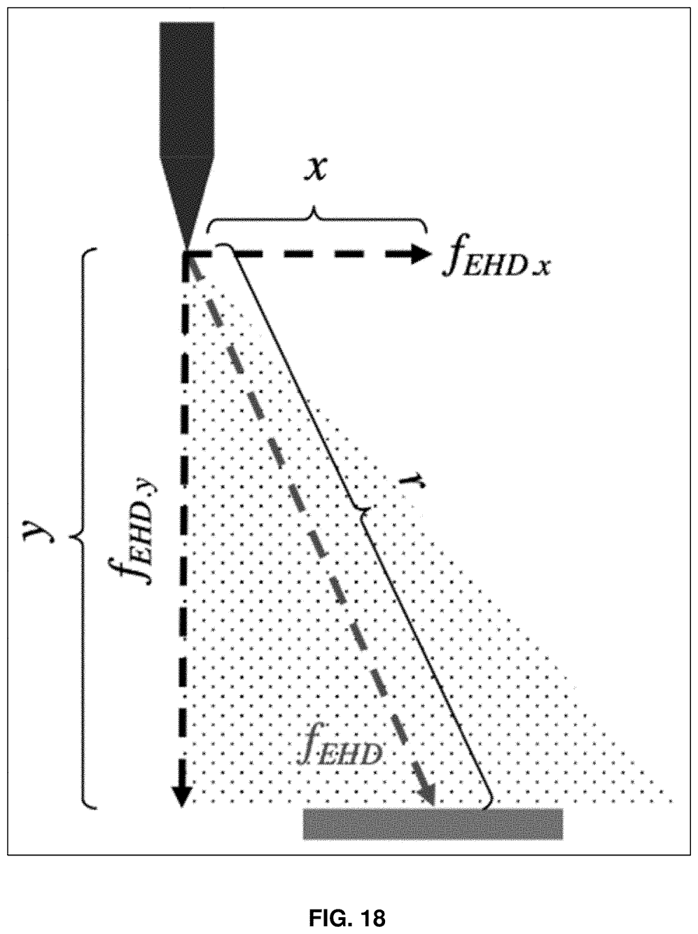

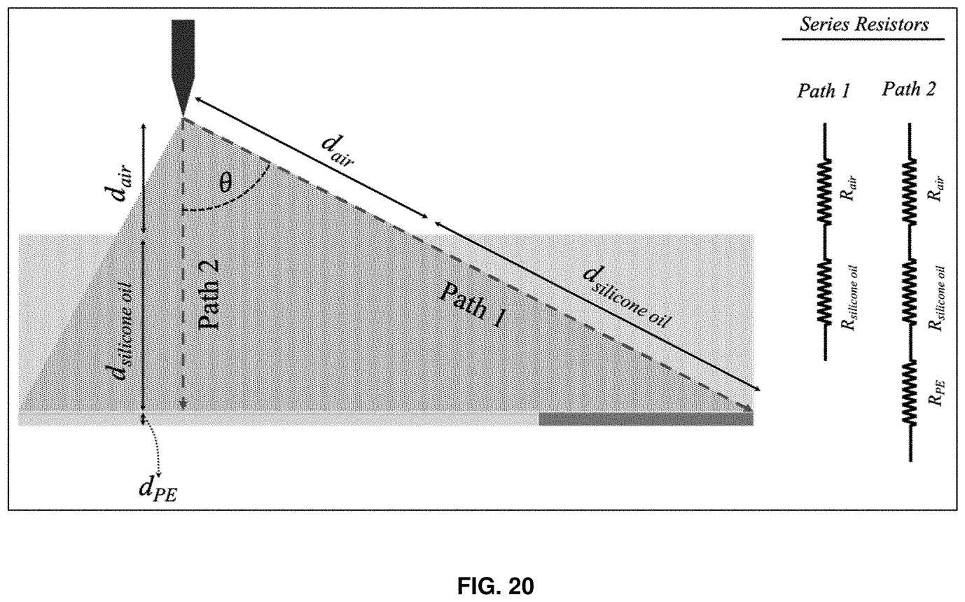

The method of indicating the fastest circulation time was based on prior experiments on the same setup. The EHD pumping in the silicone oil is a result of the external electrical force applied to the surface of the silicone oil. As a result of this force, the top surface of the silicone oil undergoes different levels of deformation from slightly concaved (downward) to severely deformed, forming a deep cone (Taylor cone) which exposes the surface of the copper ground electrode to the air based on the severity of the deformation. The desired experimental combination is in a way that the least deformation takes place. This situation is commonly seen while the processing parameters are at their highest extreme where the EHD forces are maximized The cone formation phenomenon was closely observed with an Olympus i-Speed 3 high-speed camera (iX Cameras, Rochford Essex, UK). On the other hand, when the combination of the parameters moves to the lowest level of EHD forces, the motion in the fluid becomes so slow that it can be neglected. Since water has higher electrical conductivity compared to that of air, while the humidity runs between the two electrodes, the tuned processing parameters do not respond as desired. As a result, one more round of experiments was done in order to offset the starting and ending points of each processing parameter. In order to have such a viable range of processing parameters, each separate parameter was examined for both extremes (lowest and highest) of the EHD forces. Using this method of extremums, it was possible to figure out the two ends of the parameters for each set of experiments without numerous experiments. FIG. 1 shows a schematic overview of the emulsification process. The dashed lines in FIGS. 18, 20 indicate the region which the electric field has a sensible power to cause EHD pumping. The same region is where the severe deformation of the liquid surface takes place (cone formation).

Results and Discussion

Corona discharge is resulted from a high-potential electric field discharged through a single point (the tip of the sharp tungsten needle) toward a counter electrode. Corona discharge is a branch of cold plasma discharges with slightly visible fainted blue color while the light gets more visible as a stronger electric field is applied. Due to the effect of ionization at the tip of the high-voltage discharge, the exposed media get ionized and form charged ions/particles/droplets moving in the direction of the counter electrode. Since the discharge is non-thermal and does not alter the chemical and physical properties of the exposed media or substrates, many different applications are possible with corona discharge. In the current example, corona discharge was utilized to inject charged tiny water droplets into a silicone oil medium in order to form W/O emulsions. As a high potential electric field is formed at the needle tip facing the surface of the ground electrode, a non-uniform electric field forms above and inside the silicone oil medium. This distribution is in the form of a cone with its tip at the needle tip and its base at the surface of the ground electrode. Depending on the load of the potential, positioning of the two electrodes relative to each other, and the electrical resistance in the path between them, the applied EHD forces change. As a result, the deformation of the silicone oil undergoes different levels which is reflected in a difference in circulation velocities.

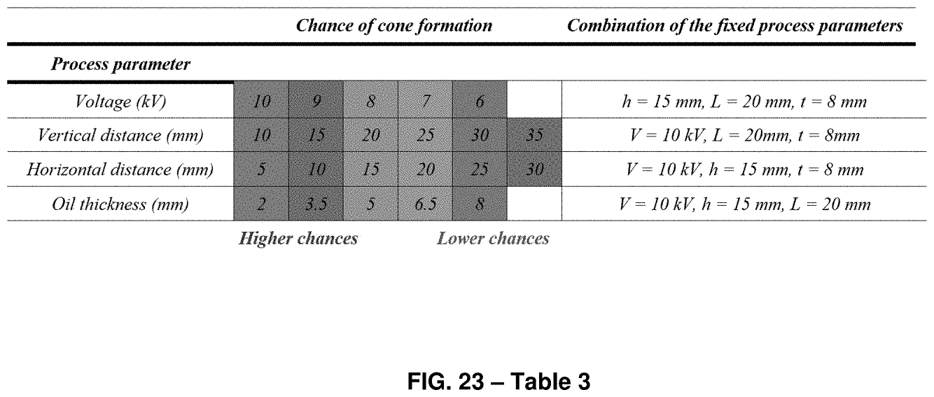

Four different processing parameters were separately studied in W/O emulsions made with a continuous phase of silicone oil 100 cSt and water droplets. The processing parameters were experimentally tuned for the start and end points of each category. The high voltage (V) which was provided by the power supply was set to start from +6 kV and in increments of 1 kV, increased to a maximum of +10 kV. The vertical distance between the sharp tungsten needle electrode and the top surface of the silicone oil (h) was set to start from 10 mm and, with increments of 5 mm, increased to a maximum of 35 mm. The horizontal distance between the tip of the sharp needle electrode and the starting edge of the ground of the copper electrode (L) was set to start from 5 mm and, with increments of 5 mm, increased to a maximum of 30 mm. Finally, the depth of the silicone oil (t) as the continuous phase of the emulsion was calculated from its initial mass and set to start from 1.5 mm and, in increments of 2 mm, it reached a maximum of 8 mm Table 3 (FIG. 23) shows the whole range of processing parameters for the four different studies. The following discussion individually analyzes the impact of each parameter based on the experimental results.

As the electric potential is applied to the needle, the non-uniform electric field forms in a cone-shaped distribution. Since the distribution of the electric field stays the same throughout the experiments (while the only variable parameter is the voltage and all other ones are kept constant), it may be considered that the resulting EHD forces have to be the same. However, with increasing the voltage, the electric field intensifies and the flow of charged particles toward the counter electrode increases. This correlation can be written in form of:

E=V·d⁻¹ (4)

where E is the electric field, V is the voltage, and d is the distance between the electrodes. These charged particles provide a momentum while impacting neutral particles which is simply what causes creation of EHD forces. Knowing the neutral particles (oil particles before applying any external electric field) are stationary, the resulting EHD forces for positively and negatively charged particles/ions can be written as follows:

f_{p,EHD}=nₚ, mₚ, vₚ, uₚ

f_{n,EHD}=nₙ, mₙ, vₙ, uₙ (5)

Where nₚ and nₙ are positive and negative ion number densities, mₚ and mₙ are the mass of positive and negative ions, and vₚ and vₙ are the frequencies of momentum exchange in positive-neutral and negative-neutral ion impacts. “p” and “n” indices represent terms related to the positive and negative ions, respectively.

To further utilize the above equation, a mobility term is identified for a given particle x, Mₓ, where it can be calculated as Mₓ=e/(mₓ, vₘ). Using this mobility factor and introducing a current density of Jₚ and Jₙ, a general equation for EHD force per volume can be derived:

f_{EHD}=Jₚ/M_{P}−Jₙ/Mₙ (6)

Roughly simplifying the above equation, it is safe to conclude that in a positive ion displacement in a positive corona discharge, the effect of negative ions can be cancelled, and the former equation can be simplified to the form of:

f_{EHD}=Jₚ/Mₚ (7)

Using Ohm's law, the correlation of voltage and current in an electrical circuit, V=I×R, where V is the applied voltage, I is the current, and R is the electrical resistance, it is apparent that if the voltage is increased, the current will increase proportionally, while the electrical resistance is kept constant. In the experiments where the effect of voltage was studied, the distance between the two electrodes and the oil thickness were kept constant, which reflects in a constant electrical resistance. As a result, with increasing the voltage, the current, which is simply the number of charged ions moving toward the counter electrode, increases. Using this conclusion and equation Error! Reference source not found.), the resulting EHD forces get stronger as the voltage is increased.

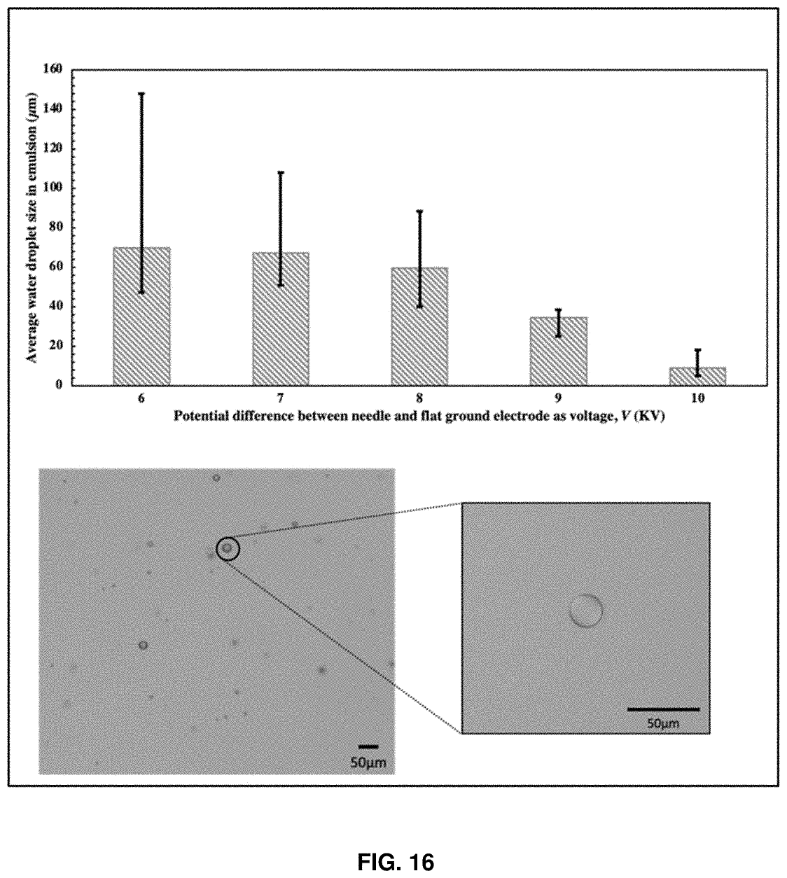

The process of emulsification via corona discharge ionizes the water droplets in the range of a strong enough electric field and shoots them toward the counter electrode. Since the grounded electrode is covered with silicone oil, the charged water droplets enter the oil and mostly stop in the middle of the continuous phase. Due to the fact that the water droplets have the same sign of charge, they tend to repel each other which enhances the stability of the emulsion product (Coulomb's force). However, in some cases, either due to a non-uniform size of water droplets, initially, or due to a lower oil circulation velocity, some droplets get trapped close to the grounding electrode. While the trapped droplets bounce up and down between the free oil surface and the ground electrode, they consume the newly entered water droplets and transform to larger droplets. The disadvantage of having larger droplets is that they get heavier as their mass augments and they sediment quickly. As a result, EHD force applied to these droplets does not overcome their resistance to move into the direction of the flow and further coalescence takes place. While this process continues to occur, the quality of the emulsion deteriorates as well as its stability. Due to this phenomenon, in lower voltages, where EHD forces are weaker, the average size of the water droplets in the emulsion increase. FIG. 16 shows the average size of water droplets in each different level of voltage.

From FIG. 16, it can be seen that the working voltage was increased from +6 kV to +10 kV with increments of 1 kV. As discussed earlier, at the lower voltages (V<+6 kV) the motion of the silicone oil was observed to be extremely slow to a point that at +4 kV, there was no motion. As a result, the lower voltages were not included in the results. On the other hand, +10 kV is the maximum voltage that the power supply in this example was able to provide. The combination of other parameters for this set of experiments were as follows: vertical distance of the needle to the top oil surface, h=15 mm, horizontal distance between the needle tip to the start of the ground electrode, L=20 mm, and depth of silicone oil, t=8 mm In the sample made under +10 kV, the velocity of the oil circulation was the highest as a result of a stronger EHD force. Gradually, as the voltage was decreased, the velocity was decreased, and the time of circulation increased. This being said, in a higher velocity, while the initial charged droplets are shot into the silicone oil, they get pushed from the highest electric field intensity by the fluid flow and they are not allowed enough time to perform an electrocoalescence due to a high electric field intensity. However, by decreasing the voltage, the velocity was decreased which provided a longer exposure time of the existing droplets in the silicone oil to be in contact with the newly added droplets. Although these droplets have a same charge sign, some of them discharge their charges and get neutral or opposite in sign which causes an electrocoalescence.

As illustrated in FIG. 16, the average size of the water droplets is increasing while the voltage is decreased. At the same time, the margin of the smallest and the largest detected droplets (the error bar) is also increasing drastically. The reason for this phenomenon is that while in lower voltages the droplets get larger due to electrocoalescence, the newly added droplets are available as well. The huge difference in size of the merged droplets and the tiny fresh droplets causes a large variation in the size. As an example, for the sample prepared under +6 kV, it can be seen that the smallest size is around 40 μm while the largest one is approximately 150 μm. Also noteworthy is that from +8 kV to lower voltages, the average size of the droplets gets stabilized in the range of 60-70 μm. The stable plateau of the average size of the water droplets is due to the fact that the samples were collected from eight different points throughout the volume of the pumping setup. Although the circulation velocity gets considerably less in lower voltages, the droplets still move and many of them manage to escape from the high intensity range of the electric field and, consequently, they do not merge with other droplets. This confirms the increasing trend in variation of the average size as well. Finally, the graph can be divided into two distinct sections of below and above +9 kV where in the left portion, the EHD forces are weak enough to let electrocoalescence take place but they are strong enough to drift the droplets out of the range of intense electric field. However, based on the experimental results, voltages of +9 kV and above are more desirable for a more uniform W/O emulsion.

The Impact of Vertical Distance on Average Size of the Water Droplets (h)

In general, using a simple law of uniform electric fields, equation Error! Reference source not found.), it can be concluded that the distance between the two electrodes directly affects the strength of the field. Where E is the strength of the electric field, ΔV is the potential difference between the two electrodes, and Δd is the distance between the two electrodes, by increasing the distance, the intensity of the electric field declines. Although this correlation is used for “uniform electric fields”, the same applies to non-uniform ones with a different order of correlation between the distance and the strength of the electric field. However, to be more accurate for the case of this example, non-uniform distribution of electric field, it is viable to use Coulomb's law for charged particles. Based on the Coulomb's law, the scalar force between two charged particles can be calculated as:

$$\vert F \vert = ( {k}_{e} \cdot \frac{\vert {q}_{1} \cdot {q}_{2} \vert}{{r}^{2}} ) and {k}_{e} = ( 1 / 4 {πϵ}_{0} ) = 8.988 \times 1 {0}^{9} N \cdot {m}^{2} \cdot {C}^{- 2} \qquad ( 8 )$$

where kₑ is called Coulomb's constant, ϵ₀ is the electric permittivity of vacuum, q₁ and q₂ are the charges of the two points, and r is the distance between the two charges. In order to derive the magnitude of an electric field from equation Error! Reference source not found., first it has to be assumed that one of the charges is acting as a source of potential and the other one is the countered electrode. By substitution and simplifying, the electric field intensity can be derived as:

$$\vert E \vert = ( {k}_{e} \cdot \frac{\vert Q \vert}{{r}^{2}} ) \qquad ( 9 )$$

where Q is the charge or potential at the single point (in the case of this example the single point is the tip of the needle), and E is the intensity of the electric field over a varying distance of r.

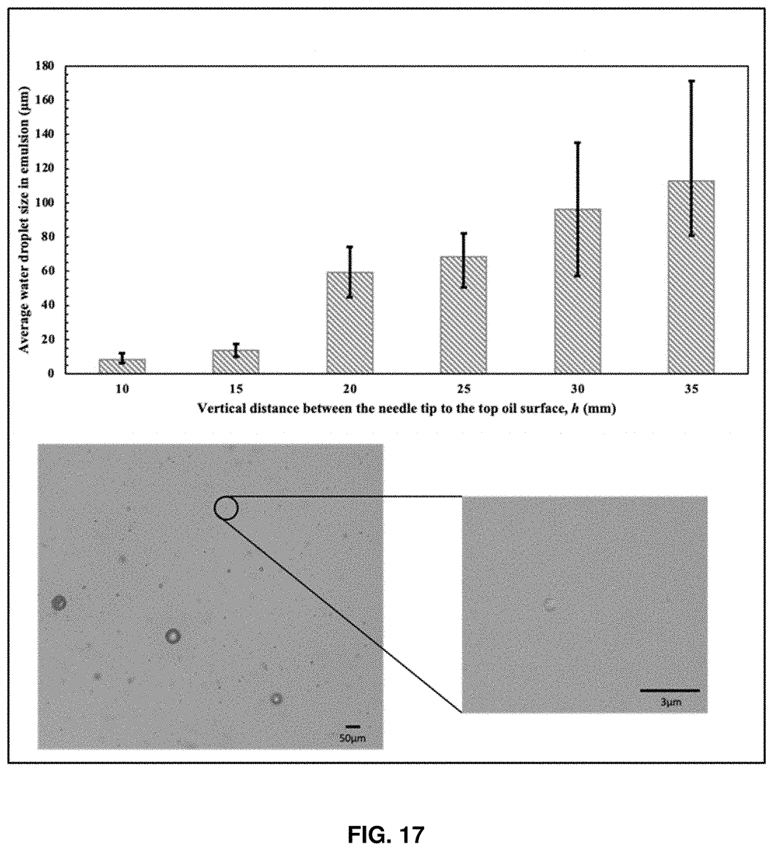

It can be seen that equation Error! Reference source not found. follows an inverse square correlation (E∝r⁻²). As the distance between the two electrodes increase, the intensity of the electric field in a constant input voltage decreases with a second order magnitude. The same discussion would be used in investigating the effect of horizontal distance of the two electrodes. Although this equation is applied in vacuum condition, with changing it to atmospheric discharge, only the permittivity coefficient, ϵ₀, changes. This change is cancelled out since in all the experiments the atmosphere between the two electrodes is the same. FIG. 17 shows the average size of the water droplets in the W/O emulsion formed in this set of experiments.

The combination of the processing parameters for this set of experiments were as follows: voltage of V=+10 kV, horizontal distance between the electrodes of L=20 mm, oil thickness of t=8 mm, and one round of circulation for all the experiments. The vertical distance between the electrodes, h, was changed from 10 and 35 mm with 5 mm increments. As can be seen from FIG. 18, by increasing the vertical distance from 10 to 35 mm, the average size of the water droplets is increasing. In the first step, for distances of 10 and 15 mm, the average size is closely in the same range but as the distance increases, a significant increase in the size could be observed. Simultaneously, the range between the smallest and the largest water droplets are getting wider. Similar to the discussion for the effect of voltage (V), the change of vertical distance is showing the same trend. While the voltages get lower, the size of the droplets get to a stabilized plateau while by increasing the vertical distance, the change becomes more severe as the intensity of the electric field is following an inverse square correlation introduced in equation Error! Reference source not found. The applied electric field generates EHD forces which have two components in vertical and horizontal directions, f_{EHD·y} and f_{EHD·x}, respectively. FIG. 18 shows the different components of the EHD forces acting on the surface of the liquid which results in a circulation motion in the pump. The term r in equation Error! Reference source not found. can be divided into two components following r²=\sqrt{x²+y²}. As the distances, horizontal (x), vertical (y), or both of them, change during the experiments, the overall acting forces change as well. Depending on the positioning of the two electrodes relative to each other, the velocity of circulation caused by different acting forces changes as well. As a result, in higher vertical distances, the distance y is increased which increases the value of distance r. On the other hand, an increase in the vertical distance, changes the angle in which the EHD forces are applied to the oil surface. For instance, in vertical distance of h=35 mm, a semi-perpendicular force is applied to the oil which is unable to efficiently move the liquid layers forward. Consequently, the circulation and fluid velocity decreases significantly which reflects in larger water droplet size.

Similar to the previously presented results for the effect of voltage, the range between the smallest and the largest droplet sizes gets wider as the vertical distance is increased. For higher distances, the intensity of the electric field gets weaker and results in a slower pace of circulation which lets many of the droplets to be trapped in the region between the two electrodes and form an electrocoalescence. The motion of the smaller trapped droplets is governed by the effect of the electric field which is known as electrophoretic (EP) force. After a number of bounces between the top surface of the oil and the ground electrode, the electrocoalescence increases the size of the droplets. Considering Coulomb's law, the larger droplets with a larger surface area need more EP force in order to continue their bouncing behavior and their speed of reciprocation will decrease. The EP force can be easily calculated using F_{EP}=E·Q where E is the intensity of the electric field and Q is the charge on the surface of the droplets. As the droplets get larger, their charge density on the surface is decreased and as a result, the generated EP forces are decreased. This mainly occurs because the charge density on the surface of a larger sphere is smaller than that of a smaller one. It appears that as the droplets get larger, their chances of getting trapped for a longer time is increased. In addition to the change in charge density and strength of EP forces, the drag force is changing as well. The correlation between the drag force and the surface area of a sphere can be calculated as:

F_{d}=½·C·ρ·A·v² (10)

where C is the drag coefficient, ρ is the density of the fluid, A is the area of the sphere, and v is the velocity of the object.

As the droplets are getting larger, their velocity is decreased due to the loss of EP forces. Simultaneously, the surface area increases as the size of the spherical droplets are increased. The combination of these two changes causes a greater reduction in mobility of the droplets in the up and down direction. Although the drag force acts in the direction of the flow as well, there is no other resisting force to hinder its further motion in the direction of the fluid flow (circulation of the emulsion). As a result, the droplets are getting larger and at the same time they escape from the range of intense electric field. Since the intensity of the electric field is maximum exactly underneath the needle and depends on the initial positioning of the droplets entered to the silicone oil, the increase in their size varies. This can be reflected in the wide range of the droplet sizes, especially in higher vertical distances. Unlike the data plotted for the effect of the voltage, the average size of the droplets increase significantly as far as the vertical distance is increased.

The Impact of Horizontal Distance on Average Size of the Water Droplets (L)

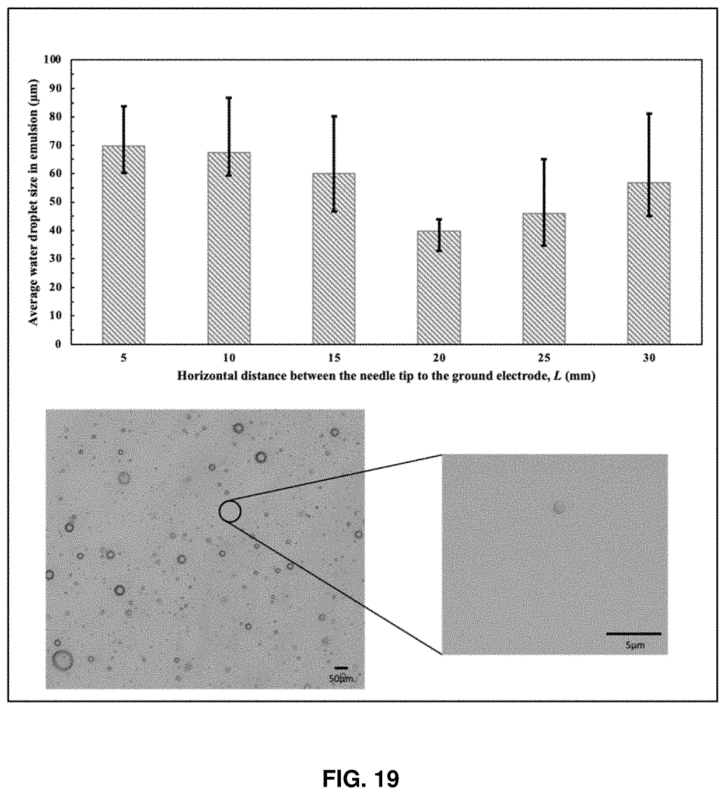

Similar to the vertical distance, changing the horizontal distance between the two electrodes changes the intensity of the electric field and as a result, the size of the water droplets in the emulsion. Returning to FIG. 18, a change in the x component of r changes the overall distance in which the EHD forces are acting. Increasing the horizontal distance is a key factor in decreasing the angle of the overall EHD forces on the oil surface. However, unlike the effect of the vertical distance, by increasing L, the average size of the water droplets does not follow an absolute inclining or declining trend. FIG. 19 show the variation of the change in water droplet size under different conditions. The processing conditions for this set of experiments were as follows: voltage of V=+8 kV, vertical distance between the two electrodes of h=15 mm, oil thickness of t=8 mm, and one round of circulation for all the experiments. The horizontal distance between the electrodes, L, was increased with increments of 5 mm from 5 to 30 mm.

As can be seen from Error! Reference source not found, with increasing the horizontal distance, the average size of the droplets decreases. However, this trend is only stable to the point where the horizontal distance reaches 20 mm After this point, it can be seen that the average size of the droplets increases once more. There are two different mechanisms affecting this behavior. In the portion of L<20 mm, in lower horizontal distances, the effect of electric field (i.e., EHD forces) becomes more inclined toward vertical direction. In this condition, the propulsive forces do not act in the direction of the fluid circulation and mostly act as a suppressing force, squeezing the top surface of the liquid downward. Due to this effect and based on the horizontal distance of the electrodes, deep cones form which hinder the forward motion of the liquid. In addition, as discussed earlier, the formation of deep cones causes a vortex which interrupts the fluid flow and makes the droplets get trapped in the region of the discharge. As a result, in lower horizontal distances, the average size of the droplets is increased. Looking into the error bars of this portion, it can be seen that they are significantly narrower compared to the ones in FIG. 17. On the other hand, it is apparent that the average size of the droplets in this region is relatively higher. It is believed that while the droplets are getting larger, and due to the fact that the propulsion forces are not sufficient, the trapped droplets get further larger by consuming the newly added tiny water droplets. Consequently, the number of intact droplets decrease, and the lower limit of the error bar goes up. This explanation justifies the higher size and size variation of the droplets.

In the right portion of the graph (horizontal distances above L>20 mm), since the distance between the two electrodes are increased significantly, the intensity of the electric field and consequently its resulting EHD forces are considerably decreased. With lower EHD forces, the velocity of circulation is less; hence, the droplets have enough time to undergo electrocoalescence, which increases their final sizes. However, looking at FIG. 19, it is apparent that the average size of the droplets is less than the right portion of the graph, although the difference is tiny. There is another mechanism triggered here which is a shift in the grounding electrode location due to increased electrical resistance. The discharge naturally prefers to take place through the least electrical resistance. The new path of discharge in higher horizontal distances becomes through the air, silicone oil, and the thickness of the petri dish. The pumping setup was made out of polyethylene (PE) which has a thickness of less than 1 mm. The pumping setup was then backed with a lab jack with a stainless steel (grounded in connection with the copper ground electrode) in order to change the height and the location of the electrodes relative to each other. The new path of the discharge occurred due to the fact that the overall electrical resistivity of the media in between the two electrodes was changing. FIG. 20 shows a schematic of the new path of discharge.

As it appears in FIG. 20, by horizontally changing the location of the grounding electrode (i.e., increasing the horizontal distance L), the corona discharge path changes as well. Using the series resistors law, it is known that in Path 1, the total electrical resistance is Rₜ=Rₐᵢᵣ+R_{silicone oil}. Likewise, for Path 2, the total electrical resistance would be calculated as Rₜ=Rₐᵢᵣ+R_{silicone oil}+R_{PE}. The values of these electrical resistances are found to be Rₐᵢᵣ=1.3˜3.3×10¹⁶, R_{silicone oil}=1×10¹³, and R_{PE}=6.15×10⁷. Using the simple law of electrical resistance and its correlation to the length of the medium, R=ρ·l/A, where ρ is the resistivity, l is the length in which the ions are moving, and A is the surface area in which the ions are moving, it can be concluded that with an increase in the distance a charge passes to reach a countering electrode, the electrical resistance increases. Now, comparing the distances of each layer of dielectric between the two electrodes, it can be written that:

d_{air 2}=d_{air 1}·cos (θ)

d_{silicone oil 2}=d_{silicone oil 1}·cos (θ)

d_{air 2}+d_{silicone oil 2}=(d_{air 1}+d_{silicone oil 1})·cos (θ)

and 0<|cos (θ)|<1 (11)

From equation Error! Reference source not found, it is clear that through Path 1, the length on which the charges move is significantly larger compared to that of Path 2, and with increasing the horizontal distance L, the difference gets larger. Considering the correlation R=ρ·l/A, with an increased length, the overall electrical resistance in Path 1 is increased as well. The discharge naturally prefers to take place in the least electrical resistance, that being said Path 2. Although the schematic figure represents a new path of discharge, since the stainless steel sheet does not have any sharp edges, the discharge is performed through random locations. The random discharges are able at some point to manipulate the fluid and form emulsions but as the distance gets increased more, a significant disturbance in the silicone oil circulation was observed, and the experiments were stopped at horizontal distance of L=30 mm. The main reason for this disturbance is the uniformity of the stainless steel sheet geometry, which does not have any sharp point to guide the discharge to that region and form an actual electrode with an ability to guide the discharge. Despite the fact that the size of the droplets in the right portion of the graph (L<20 mm) were smaller compared to those on the left side (L>20 mm), the irregularities were higher. As can be seen from FIG. 19, the irregularities are reflected in the form of wider size variation between the largest and the smallest droplet sizes. It is also noteworthy that the reason behind not selecting the voltage V=+10 kV for this set of experiments was that at this voltage, and especially in lower distances, the cone formation was so severe that it completely interrupted with circulation of the silicone oil. Consequently, a high-quality comparison between the different horizontal distances was not possible. Thus, a lower voltage of V=+8 kV was tested and proved to be suitable to identify the effect of a wider range of horizontal distances.

The other verification may be Warburg's law, which indicates that the existing current density on the surface of a dielectric is changing with a change in the angle between the tip of the needle and a point on the surface of the dielectric. This correlation can be written as follows:

$$J = \frac{{I}_{c}}{2 {t}^{2}} \vert {( cos ( θ ) )}^{n} \vert and α \leq 65 ° \qquad ( 12 )$$

where J is the current density, I_{c} is the corona discharge current, t is the gap between the two points, θ is the angle in which the charged particles are moving toward the surface of the dielectric medium, and n is a constant.

As can be seen from equation Error! Reference source not found.), by increasing the value of θ, the current density decreases. At the maximum horizontal distance of 30 mm, θ≈63°, which is in the threshold of the angles introduced by Warburg's law. However, due to a shift in the location of the ground electrode, a different behavior was observed at higher horizontal distances.

The Impact of Oil Thickness on Average Size of the Water Droplets (t)

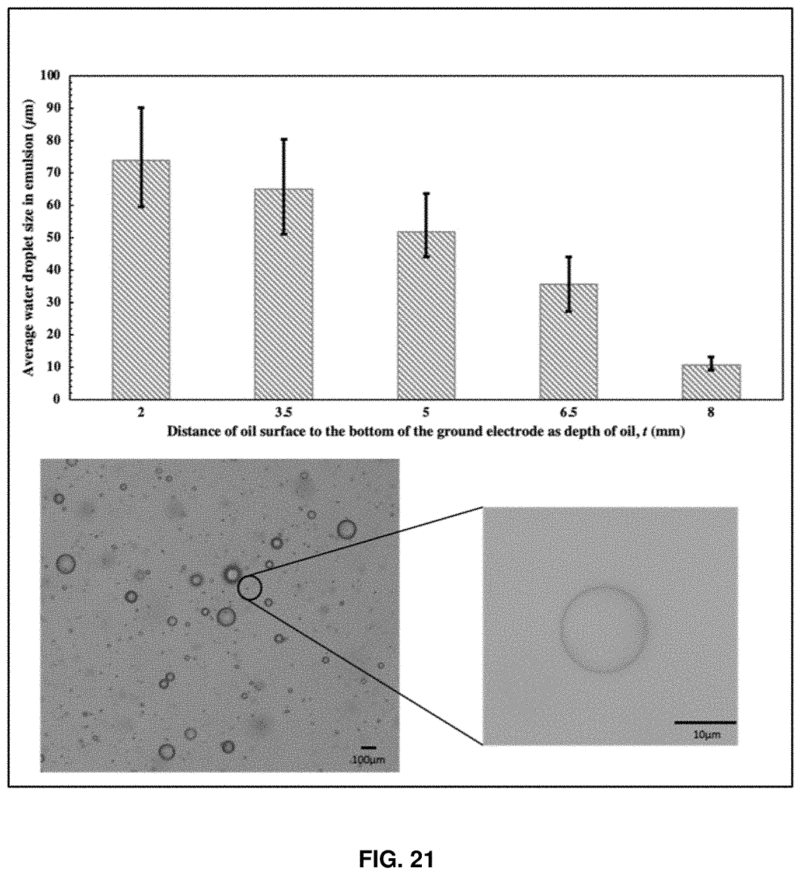

The last studied parameter is the effect of the oil thickness or the height of the silicone oil from the surface of the ground copper electrode to the top surface of the oil in any given combination of parameters. Similar to the other parameters, a change in the oil thickness results in alterations in fluid behavior between the two electrodes which itself influences the electroemulsification characteristics. Although the EHD forces are in action for manipulation of the injected water droplets in silicone oil medium, other mechanisms are as well involved in determining the average size of the water droplets in the W/O emulsion product. FIG. 21 represents the various size measurements for different processing oil thicknesses with a fixed combination of other parameters as: voltage of V=+8 kV, vertical distance of h=15 mm, horizontal distance of L=20 mm, and one round of processing. The oil thickness was varying between 2 mm and 8 mm with 1.5 mm increments. It should be noted that the initial vertical distance of h=15 mm was measured from the top surface of the oil in depth of t=8 mm (it was set to a constant value of 23 mm from the tip of the needle to the surface of the ground electrode). Consequently, by decreasing the oil thickness, the vertical distance was changed in increments of 1.5 mm.

As can be seen from FIG. 21, the average size of the droplets is increasing while the oil thickness decreases. Considering equation Error! Reference source not found. and using the rule of electrical resistance, R=ρ·l/A, it appears that with increasing or decreasing the oil thickness, the resisting layers between the two opposing electrodes change. Keeping in mind that the media, combined layers of air and silicone oil, are the same for all the experiments in this set, changing the oil thickness means that the electrical resistance between the electrodes is increased. By decreasing the oil thickness, the thickness of the air layer between the two electrodes increases. Consequently, an increased air thickness results in an increased electrical resistance (Rₜ=Rₐᵢᵣ+R_{silicone oil}) as the electrical resistivity of air is nearly 3 orders of magnitude higher than that of the silicone oil. Although the air medium is humid due to presence of the water droplets, the electrical conductivity does not change significantly to cancel the high electrical resistivity of air and the discussion remains the same even with presence of water droplets. Unlike the ground electrode shifting phenomenon discussed previously, the increased electrical resistance does not result in a ground electrode shift. The reason for this double-sided behavior is that when the oil thickness is changed, the distances are still the same, which means that the high-potential electrode still prefers to discharge through the grounded copper electrode. The discharge in this case tries to make its way to the ground electrode by any means and, as a result, a severe disturbance occurs in the oil layers.

When the oil thickness decreases, the electrical resistance increases and, as a result, the charged object shot toward the ground electrode gets stuck behind the resistances (a combination of air and oil layers). This causes a gradual increase in the electrical pressure behind the resisting layers which is reflected in an increase of current density and a transient higher conductivity of the resistances. When this condition is met, a sudden discharge of the charged particles quickly move toward the opposing electrode. This discharge regime is similar to what takes place in capacitor discharge with a difference that the discharged regime does not fade away since the high-potential electrode is constantly feeding the charged objects. The current density of the trapped charges above the oil surface can be calculated as follows:

\vec{J}=σ·\vec{E} and J=I/A (13)

where J is the current density (number of the trapped charges on a given surface area), σ is the conductivity of the media, E is the electric field strength, I is the current imposed by the electric field, and A is the surface area on which the charges are adding pressure. As the current (the number of trapped charges) increases in a constant surface area and electrical conductivity, the current density increases, which results in a higher electric field intensity. Since the strength of the electric field is a direct function of surface charges (the total number of the trapped charges from the electric field and the charged water droplets), a local increase in the electrical field strength increases the number of charged particles trapped on the surface of the silicone oil. The following equation represents the correlation of the electric field strength and the trapped charged droplets:

E=σ/ϵ₀ (14)

where σ is the surface charge density and ϵ₀ is the dielectric permittivity of vacuum. As the surface charges are increased (the total charge of the trapped charges from the electric field and the charged water droplets), the electrostatic pressure on the surface of the dielectric barrier (silicone oil) increases. With excessive electrostatic pressure in locally stronger electric fields, the surface of the dielectric deforms severely to a point that it forms deep cones. The following equation represents the electrostatic pressure caused by the excessive number of trapped charges on the oil surface:

p=σ²/2ϵ₀=0.5 ϵ₀·E² (15)

where p is the electrostatic pressure caused by the surface charges. Following equations Error! Reference source not found.)-(14), it can be concluded that with a simple change in the oil thickness, and as a result, the electric conductivity of the medium between the two electrodes, the behavior of the silicone oil and the emulsion formation process undergoes a significant change.

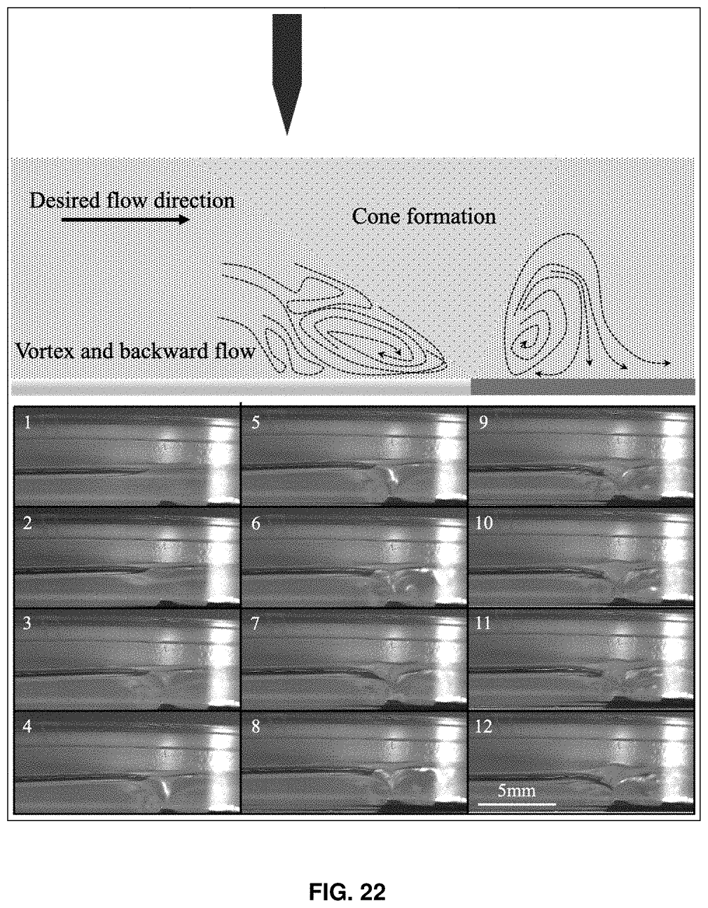

Discussing the mechanisms taking place during change of oil thickness, the explanation of the droplet size change becomes more straightforward. As the surface of the oil is forcibly deformed to make a discharge between the electrodes, the charged water droplets find their way toward the grounding copper tape. The deep cone formation causes a vortex in the silicone oil which interrupts the circulation of the oil and results in electrocoalescence of water droplets. Based on observations during the experiments, the cone formation takes place in the middle of the pumping channel and around the cone there is still a circulation flow visible, even though it is very weak. Based on the severity of the cones, the velocity of the flow is variable. With this weak flow, the droplets finally get pushed out of the vortex region by EHD forces and do not undergo more enlargement. However, in some conditions, the flow is not guaranteed, especially at lower oil thicknesses and higher voltages. In this condition, the magnitude of the cone gets worse and the droplets get trapped permanently, resulting in an infinite increase in water droplet size up to a point that there are two distinct phases of water and oil visible in the pumping setup. Due to this, the acting voltage of this set of experiments was set to V=+8 kV (instead of +10 kV) in order to prevent such a phenomenon. Having extremely large water droplets increases the difference between the largest and the smallest droplets in a way that the analyzed images do not give a conclusive and meaningful outcome. FIG. 22 shows how these cone formations cause vortices from which a high disturbance in the circulation flow occurs. As can be seen, even some portions of the fluid locally try to move in the opposite direction of the desired flow. Although the backward flow is not permanent, it significantly reduces the circulation velocity of the silicone oil. This opposing motion was observed to be higher in lower oil thicknesses that resulted in a more chaotic and irregular circulation of the emulsion. The oil thicknesses around 8 mm are most effective (with the introduced combination of process parameters) in order to have the smoothest flow and the most uniform distribution of water droplet size.

As can be seen from FIG. 22, the vortices are disturbing the desired flow of the fluid inside the pump which is caused by EHD forces. In the 12 distinct steps of a vortex formation, it can be clearly seen that once a vortex is born, it remains in a different form or intensity but its entity and effect on the flow remain throughout the process. In the initial steps, the surface of the oil is deformed due to the electrostatic pressure of the charges. Once the pressure surpasses the surface tension, a deep vortex in the shape of a cone forms which consequently generates undesired flows before and after its location. The disturbed flow behind the vortex is the one that extremely affects the desired flow of fluid in the pump. As is illustrated, the disturbed flows before and after the vortex remain as long as the vortex is in action.

Knowing all the phenomenon taking place in the cone formation, it is useful to represent the mathematical correlations of the oil thickness and the depth and the shape of the cone. In order to form a deep cone, first the surface tension of the fluid has to be surpassed. The pressure it takes to break through the surface tension of the fluid has to be equal to or more than the reacting pressure coming from the surface tension itself. The difference between the reacting surface tension pressure and the electrostatic pressure is a function of the distance of the deformed fluid surface and the applied voltage. When the distance (the thickness of the silicone oil in this case) changes and the voltage increases to a threshold level, the surface tension breaks and a deep cone forms. This correlation can be written as follows:

p_{y}−p_{E}=(rₐ·(2γ−2.68ϵ₀·Vₐ²·d₁⁻¹))⁻¹ (16)

Vₜ=0.863(γ·d₁/ϵ₀)^{0.5} (17)

where p_{γ} is the reacting surface tension pressure, p is the electrostatic pressure, γ is the surface tension, Vₐ is the acting voltage on the surface of the fluid, Vₜ is the threshold voltage to break the surface tension, d₁ is the distance between the surface of the silicone oil to the grounded electrode, ϵ₀ is the dielectric permittivity of the vacuum, and rₐ is the radius of curvature of the best fitting circle to the tip of the cone. Considering equations Error! Reference source not found.—Error! Reference source not found., it can be seen that with a decreased oil thickness, when the voltage is increased, the Taylor cone intensifies, and that is exactly why the voltage of +10 kV was not selected for studying the effect of oil thickness, in order to avoid severe cone formations.

With the investigation on the effect of the oil thickness, it is now clear how the different elements of the electroemulsification process via corona discharge affect the behavior of the fluid circulation and the average size of the droplets in a W/O emulsion. Knowing the effect of each specific parameter paves the way for optimizing and tuning of the emulsion formation process in order to get to a specific W/O emulsion with a designed set of characteristics.

Conclusion

A non-uniform corona discharge in W/O emulsion formation has been investigated in this example. The impact of each processing parameters, namely, the effect of a DC voltage, vertical and horizontal gaps between the two working electrodes, and the thickness of the silicone oil, have been experimentally studied. Using a set of optical microscopy imaging and image processing using Python and ImageJ, the size of the droplets in each image captured for the samples have been measured. By averaging seven different samples of each experiments, the highest uniformity and accuracy in the calculated results was sought. The experimental results have been presented followed by discussion of the physics behind each liquid manipulation and deformation mechanism. The conclusions made after this discussion can be summarized as follows.

The highest variation of water droplet size was observed while studying the effect of voltage. As it can be seen in the corresponding discussion, in lower voltages, the variation of the droplet size intensifies, which reflects in the high impact of voltage on altering the characteristics of the emulsions.

In the study of horizontal and vertical distances between the electrodes, it was seen that the vertical distance plays a more important role as the difference in size of the droplets for this example were significantly diverse, relative to that of the horizontal distance.

The effect of the horizontal distance is to some point different than that of the vertical distance as it follows an inclining and declining behavior in the same set of experiments, but the effect of horizontal distance is less significant.

The oil thickness plays an important role in having a smooth and uniform flow. As the depth of silicone oil decreases, more severe cone formations occur which disturb the fluid flow critically. However, throughout the experiments on different oil thicknesses, although the average size is decreased by an increase in the oil thickness, the variation of the smallest and the largest droplet size were not far apart.

Considering the variation is size of the formed emulsions, it comes out that the effects of voltage and vertical distance were the most prominent ones in determining the uniformity of the produced emulsion.

Considering the results presented in this example, the best working combination of processing parameters for this example setup is voltage of V=+10 kV, vertical distance of h=15 mm, horizontal distance of L=20 mm, oil thickness of t=8 mm, and one round of circulation on silicone oil 100 cSt, mixed with 1 wt. % Span 80 surfactant agent.

### Example III

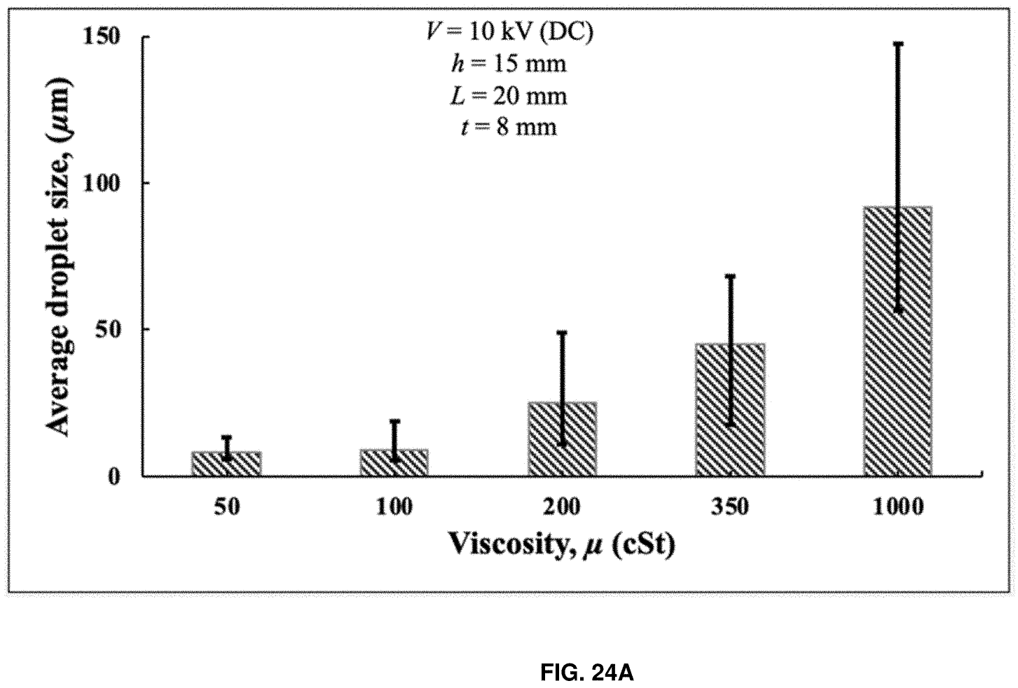

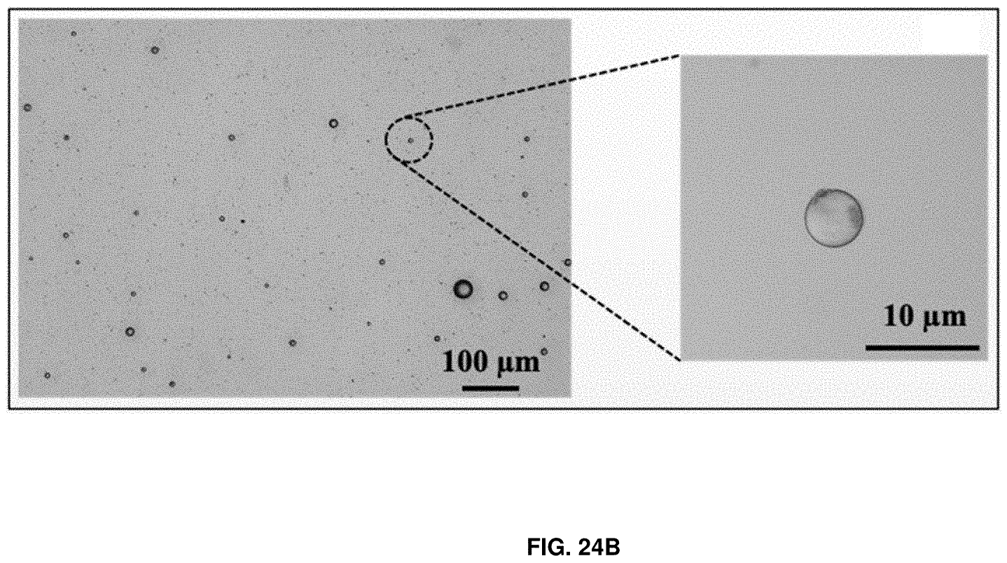

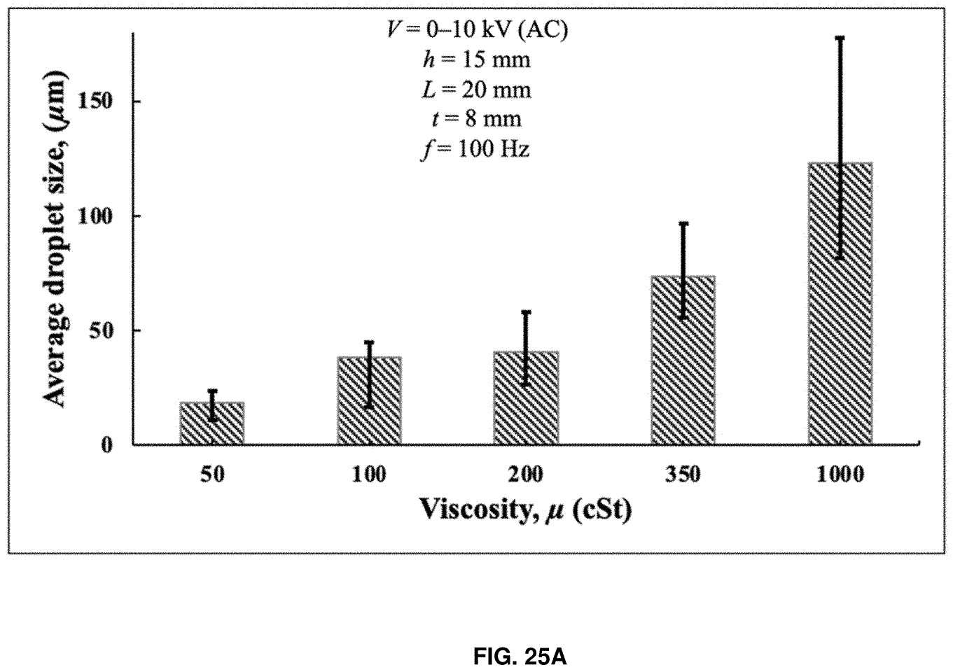

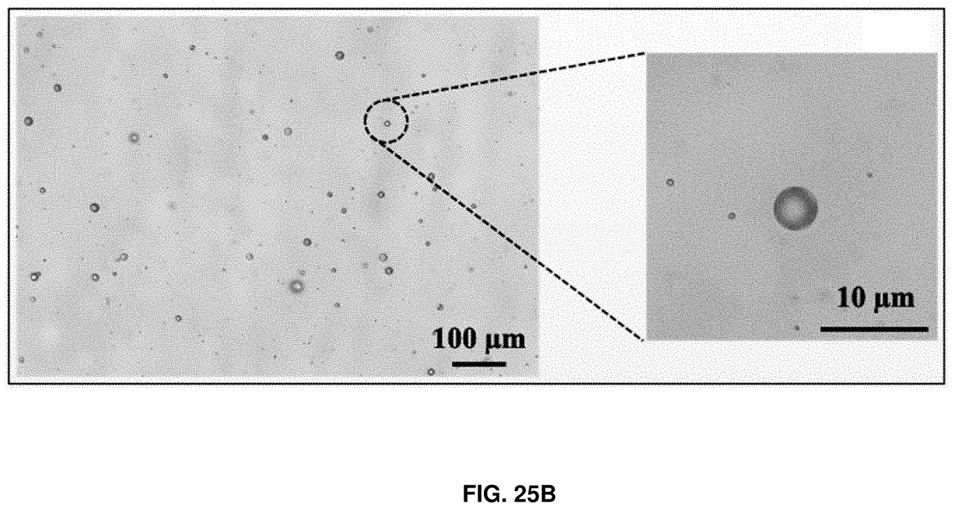

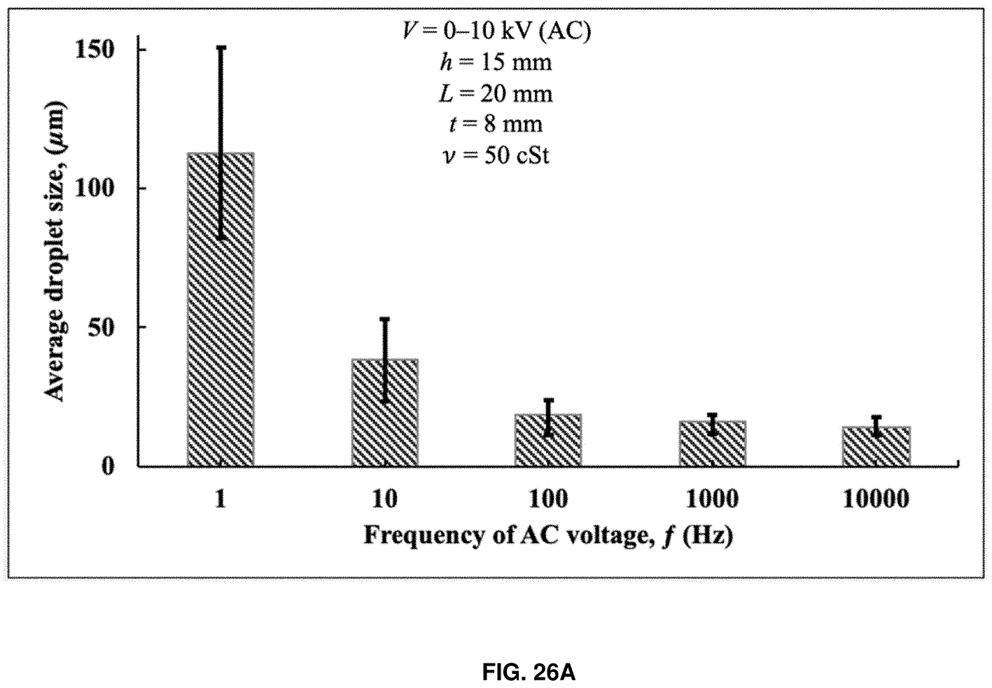

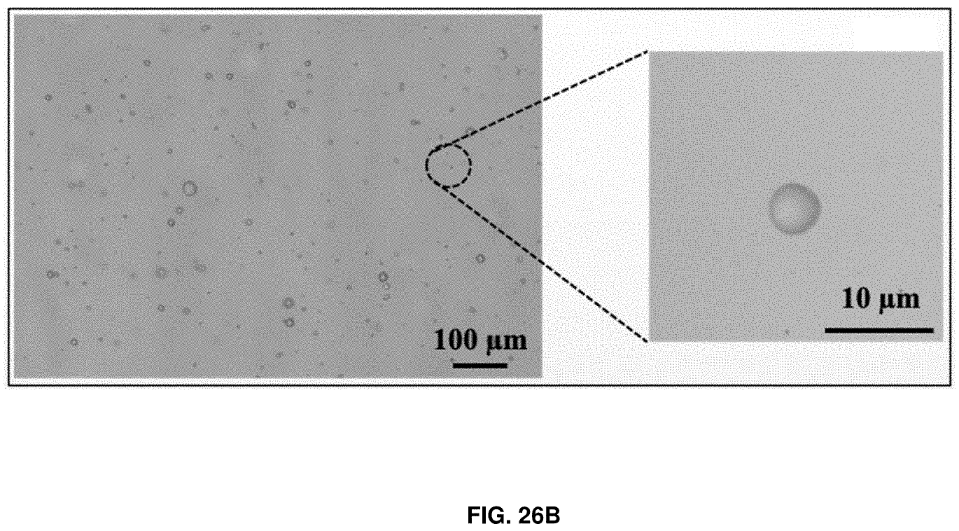

FIGS. 24-26 show the observed correlation between oil viscosity and water droplet size, and between AC electric field frequency (FIG. 25A) or DC electric field frequency (FIG. 24A) and water droplet size, in W/O emulsions. This provides for power efficient W/O emulsion formation. As seen from FIGS. 24-25, as viscosity increases, the size of the water droplets increases while the uniformity decreases. As seen from FIGS. 26A-26B, as the frequency increases, the size of the water droplets decreases and the uniformity increases

Certain embodiments of the compositions, systems, and methods disclosed herein are defined in the above examples. It should be understood that this example, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions, systems, and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A method for forming a water-in-oil (W/O) emulsion, the method comprising:
subjecting a corona emitting electrode to a high voltage sufficient to form a corona discharge and to create an ionic wind drifting in a direction toward a ground electrode, wherein the ground electrode is immersed in a fluid comprising a first phase comprising an oil at a position offset from the corona emitting electrode, and wherein the corona discharge causes electrohydrodynamic pumping of the fluid; and
introducing a second phase comprising water to the ionic wind while the fluid is moving from the electrohydrodynamic pumping so as to introduce charged particles of the second phase to the fluid and cause the charged particles to diffuse and submerge as droplets in the first phase and thereby form a W/O emulsion.

2. The method of claim 1, further comprising collecting and removing the W/O emulsion.

3. The method of claim 1, wherein the the droplets are micro- to nano-sized droplets.

4. The method of claim 1, wherein the first phase comprises silicone oil.

5. The method of claim 1, wherein the fluid consists of the first phase prior to the introduction of the second phase to the flow of ionized particles.

6. The method of claim 1, wherein the method is a continuous process such that the second phase is continuously introduced, the fluid is continuously allowed to move, and the W/O emulsion is continuously collected and removed.

7. The method of claim 1, wherein a second corona discharge is emitted from a second corona emitting electrode, and the channel further comprises a second ground electrode disposed at a distance away from the second corona emitting electrode greater than a distance between the second corona emitting electrode and the ground electrode.

8. The method of claim 1, wherein the high voltage is alternative current.

9. The method of claim 1, wherein the high voltage is direct current.

10. The method of claim 1, further comprising adjusting a velocity of the first liquid phase by changing one or more parameters selected from the group consisting of voltage, electrode configuration, oil viscosity in the first fluid phase, and operating frequency.

11. A method for forming a water-in-oil (W/O) emulsion, the method comprising:
emitting a corona discharge from a corona emitting electrode to provide a flow of ionized particles moving in a direction toward a ground electrode, wherein the ground electrode is immersed in a fluid comprising a first phase comprising an oil;
causing relative motion between the fluid and the corona emitting electrode;
introducing a second phase comprising water to the flow of ionized particles so as to introduce charged particles of the second phase to the fluid during the relative motion; and
allowing the relative motion to cause the charged particles of the second phase to spread out as droplets in the first phase and thereby form a W/O emulsion.

12. The method of claim 11, wherein the relative motion is caused by introducing a flow of the fluid.

13. The method of claim 11, wherein the relative motion is caused by moving the corona emitting electrode relative to the ground electrode.

14. The method of claim 11, wherein the corona emitting electrode is disposed a distance d away from the fluid, and is offset from the ground electrode by a length L, and wherein L is at least equal to or greater than 2.15*d(tan(65)*d).

15. A system for creating a water-in-oil (W/O) emulsion comprising:
a channel configured to receive a fluid;
a ground electrode disposed in the channel;
a corona emitting electrode disposed at a distance away from the channel and configured to emit a corona discharge; and
a source of water droplets in proximity to the corona emitting electrode so as to be configured to provide the water droplets in a space between the corona emitting electrode and the channel.

16. The system of claim 15, wherein the corona emitting electrode is offset from the ground electrode.

17. The system of claim 15, wherein the corona emitting electrode is configured for relative movement with respect to a liquid phase in the channel.

18. The system of claim 15, further comprising a power source and an amplifier configured to supply a differential potential to the corona emitting electrode.

19. The system of claim 15, wherein the source of water droplets is a humidifier.

20. The system of claim 15, wherein the channel is circular.

21. The system of claim 15, wherein the channel comprises an inlet and an outlet.

22. The system of claim 15, further comprising a second corona emitting electrode and a second ground electrode, wherein the second ground electrode is in the channel, and wherein the second corona emitting electrode is disposed at a position offset from the second ground electrode by a distance that is lesser than a distance from the second corona emitting electrode to the ground electrode.

23. The system of claim 22, further comprising a second source of water droplets configured to provide water droplets in proximity to the second corona emitting electrode.
